(19) United States
(12) Patent Application Publication
(10) Pub. No.: US 2014/0202278 A1
(43) Pub. Date: Jul. 24, 2014

(54) DYNAMIC DAMPER DEVICE

(71) Applicant: Kiyohito Murata, Susono-shi (JP)

(72) Inventor: Kiyohito Murata, Susono-shi (JP)

(73) Assignee: TOYOTA JIDOSHA KABUSHIKI KAISHA, Toyota-shi, Aichi (JP)

(21) Appl. No.: 14/234,822

(22) PCT Filed: Oct. 5, 2011
(86) PCT No.: PCT/JP2011/073007

§ 371 Date: Jan. 24, 2014

(51) Int. Cl. F16F 15/126; B60K 6/10

(52) U.S. Cl. CPC F16F 15/126; B60K 6/10
USPC 74/574.4

(57) ABSTRACT

A dynamic damper device includes a damper mass device in which a damper mass is coupled by way of an elastic body to a rotation shaft of a power transmitting device capable of gear shifting a rotation power by a main transmission and transmitting the power to a drive wheel of a vehicle, and a damper transmission that is arranged on a power transmission path between the elastic body and the damper mass and that gear shifts the rotation power transmitted to the damper mass at a gear ratio corresponding to a gear ratio of the main transmission, wherein the damper mass device can accumulate the rotation power transmitted to the damper mass as inertia energy. Therefore, the dynamic damper device has an effect of achieving both reduction in vibration and improvement in fuel economy performance.

### FIELD

The present invention relates to a dynamic damper device.

### BACKGROUND

Patent literature 1 discloses a hybrid automobile mass damper that performs control to reduce a torsional resonance vibration using an inertia of an electric motor in combination with a spring, for example, as a conventional dynamic damper device.

### CITATION LIST

### Patent Literature

Patent Literature 1: Japanese Patent Application Laid-open No. 2003-314614

### SUMMARY

### Technical Problem

The hybrid automobile mass damper described in patent literature 1 still can be improved in terms of reducing the vibration and improving the fuel economy performance, for example.

In light of the foregoing, it is an object of the present invention to provide a dynamic damper device capable of achieving both reduction in vibration and improvement in fuel economy performance.

### Solution to Problem

In order to achieve the above mentioned object, a dynamic damper device according to the present invention includes: a damper mass device in which a damper mass is coupled by way of an elastic body to a rotation shaft of a power transmitting device capable of gear shifting a rotation power by a main transmission and transmitting the power to a drive wheel of a vehicle; and a damper transmission configured to be arranged on a power transmission path between the elastic body and the damper mass, and to shift the rotation power transmitted to the damper mass at a gear ratio corresponding to a gear ratio of the main transmission, wherein the damper mass device can accumulate the rotation power transmitted to the damper mass as inertia energy.

Further, in the dynamic damper device, it is possible to further include a first control device configured to control the damper mass device, accumulate the inertia energy in the damper mass at a time of non-gear shift operation of the main transmission and at the time an acceleration request operation on the vehicle is canceled, and discharge the inertia energy accumulated in the damper mass at a time of gear shift operation of the main transmission or at the time the acceleration request operation on the vehicle is performed.

Further, in the dynamic damper device, it is possible to configure that the first control device prioritizes the discharging of the inertia energy accumulated in the damper mass over generation of power by an internal combustion engine that generates power to be transmitted to the rotation shaft.

Further, in the dynamic damper device, it is possible to further include a second control device configured to control the damper transmission, wherein the rotation shaft is an output shaft of the main transmission, and the second control device controls the damper transmission to change the gear ratio of the damper transmission and raise an output rotation speed from the damper transmission at the time of accumulating the inertia energy in the damper mass.

Further, in the dynamic damper device, it is possible to further include a third control device configured to control the main transmission, wherein the rotation shaft is an input shaft of the main transmission, and the third control device controls the main transmission to change the gear ratio of the main transmission and raise an input rotation speed to the damper transmission at the time of accumulating the inertia energy in the damper mass.

Further, in the dynamic damper device, it is possible to further include a fourth control device configured to control the damper mass device to raise a rotation speed of the damper mass at the time of accumulating the inertia energy in the damper mass.

Further, in the dynamic damper device, it is possible to configure that the damper mass device is configured to include a planetary gear mechanism including a plurality of differentially rotatable rotating elements in which the damper mass is arranged in one of the plurality of rotating elements, and a rotation control device that controls rotation of the rotating elements, provides a variable inertia mass device that variably controls an inertia mass of the damper mass, and accumulates the inertia energy or discharges the inertia energy by that the rotation control device controls the rotation of the rotating element.

Further, in the dynamic damper device, it is possible to configure that the variable inertia mass device makes the inertia mass of the damper mass relatively small in a state before the accumulation of the inertia energy by the damper mass, compared to a state after the accumulation of the inertia energy by the damper mass.

Further, in the dynamic damper device, it is possible to further include an engagement device capable switching between a state in which the rotation shaft and the damper mass device are engaged to be able to transmit power and a state in which the engagement is released; and a fifth control device configured to control the engagement device to make the engagement device in the released state and adjust deceleration of the vehicle with a braking force generated by an engine brake, which uses a rotation resistance of an internal combustion engine that generates a power to be transmitted to the rotation shaft, or a braking device in the released state of the engagement device, at the time of changing the gear ratio of the damper transmission.

### Advantageous Effects of Invention

The dynamic damper device according to the present invention has an effect of being able to achieve both reduction in vibration and improvement in fuel economy performance.

### BRIEF DESCRIPTION OF DRAWINGS

FIG. 1 is a schematic configuration diagram of a dynamic damper device according to a first embodiment.

FIG. 2 is a schematic configuration diagram of the dynamic damper device according to the first embodiment.

FIG. 3 is a schematic configuration diagram of a damper mass device of the dynamic damper device according to the first embodiment.

FIG. 4 is a collinear view illustrating the operation of a planetary gear mechanism of the dynamic damper device according to the first embodiment.

FIG. 5 is a flowchart explaining one example of control performed by an ECU according to the first embodiment.

FIG. 6 is a schematic configuration diagram of a dynamic damper device according to a second embodiment.

FIG. 7 is a collinear view illustrating an operation of a planetary gear mechanism of the dynamic damper device according to the second embodiment.

FIG. 8 is a collinear view illustrating the operation of the planetary gear mechanism of the dynamic damper device according to the second embodiment.

FIG. 9 is a collinear view illustrating the operation of the planetary gear mechanism of the dynamic damper device according to the second embodiment.

FIG. 10 is a collinear view illustrating the operation of the planetary gear mechanism of the dynamic damper device according to the second embodiment.

FIG. 11 is a flowchart explaining one example of control performed by the ECU according to the second embodiment.

FIG. 12 is a flowchart explaining one example of fly wheel energy zero control performed by the ECU according to the second embodiment.

FIG. 13 is a schematic configuration diagram of a dynamic damper device according to a third embodiment.

FIG. 14 is a schematic configuration diagram of the dynamic damper device according to the third embodiment.

FIG. 15 is a schematic configuration diagram of the dynamic damper device according to the third embodiment.

FIG. 16 is a flowchart explaining one example of control performed by the ECU according to the third embodiment.

### DESCRIPTION OF EMBODIMENTS

Embodiments according to the present invention will be hereinafter described in detail based on the drawings. It should be noted that the present invention is not limited by the embodiments. Furthermore, the configuring elements in the embodiments described below include elements that can be easily replaced by those skilled in the art and that are substantially the same.

### First Embodiment

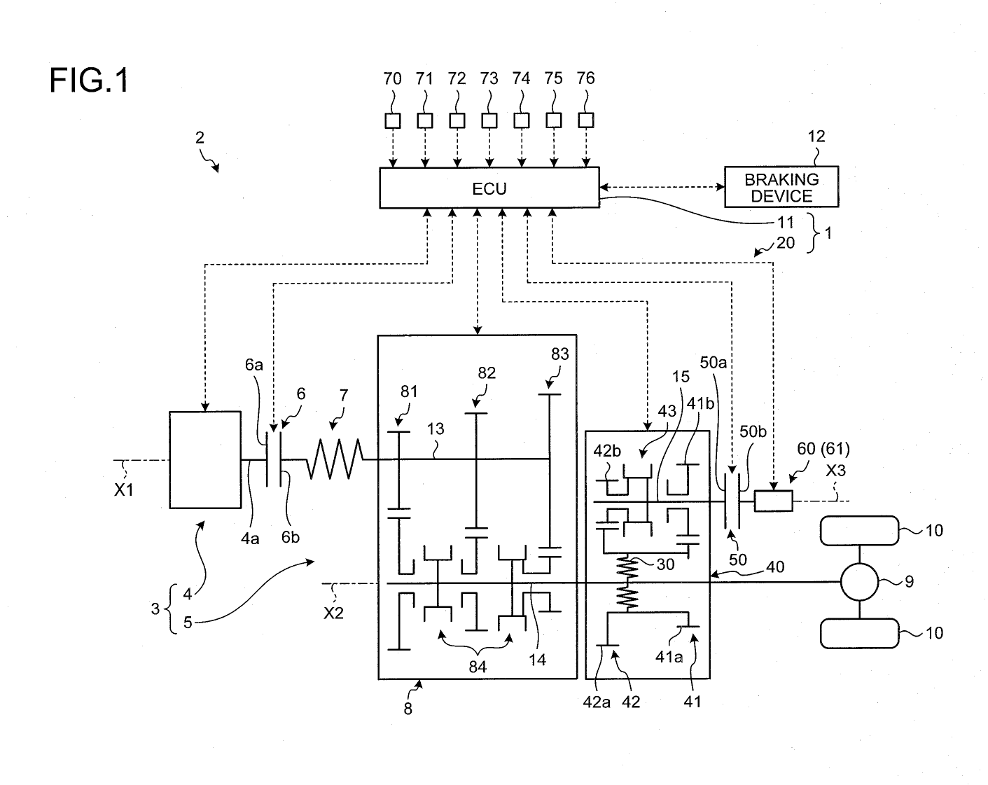

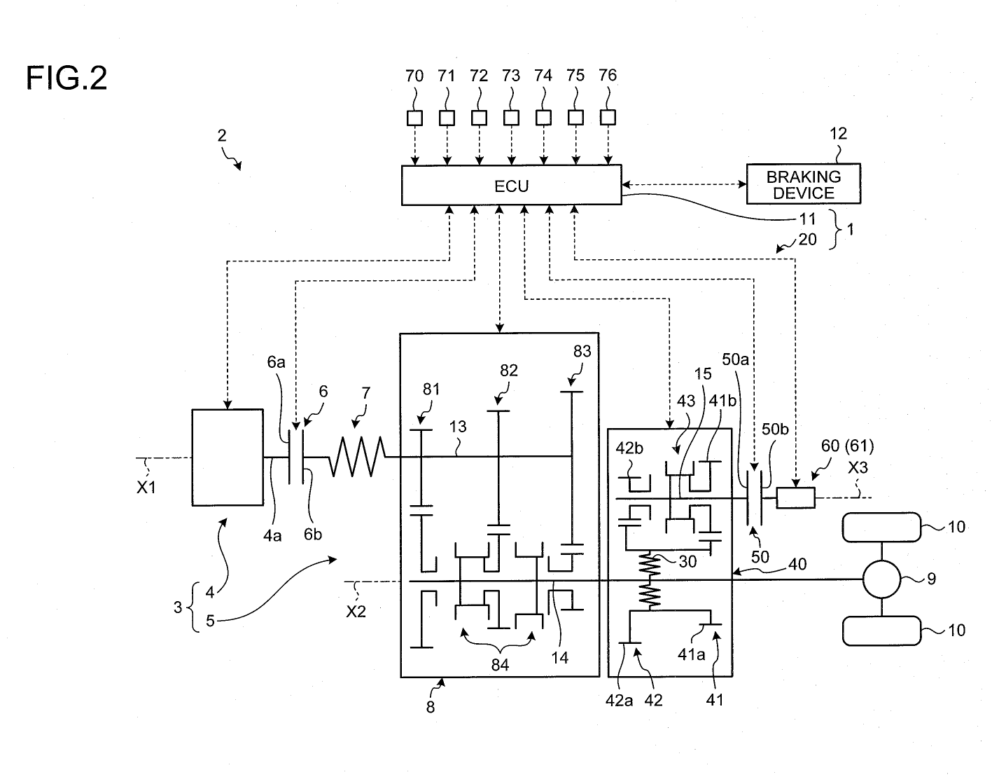

FIG. 1 and FIG. 2 are schematic configuration diagrams of a dynamic damper device according to a first embodiment,

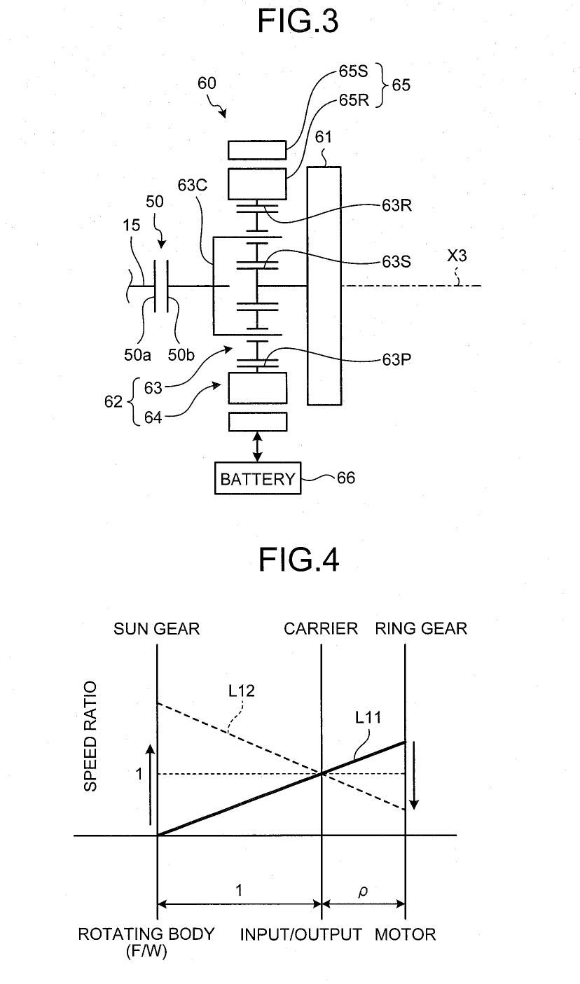

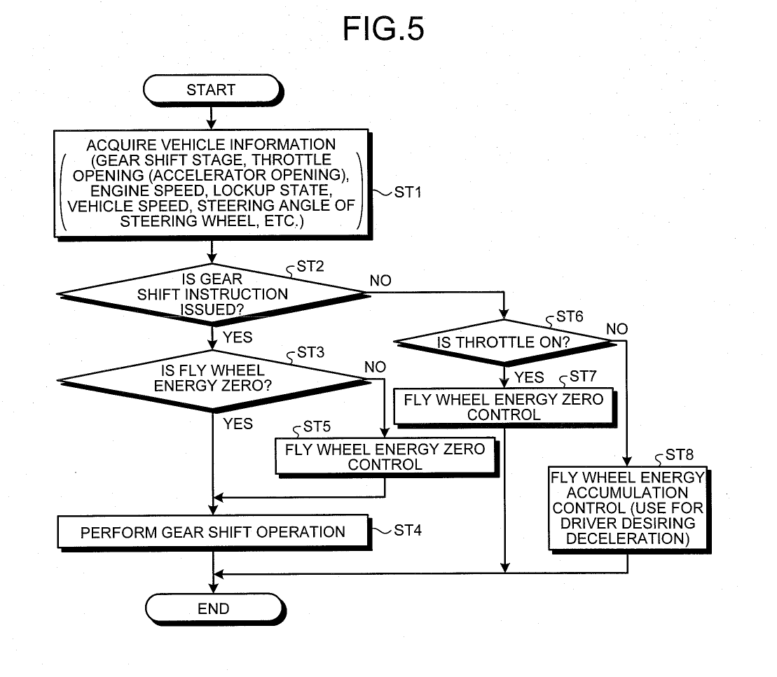

FIG. 3 is a schematic configuration diagram of a damper mass device of the dynamic damper device according to the first embodiment, FIG. 4 is a collinear view illustrating the operation of a planetary gear mechanism of the dynamic damper device according to the first embodiment, and FIG. 5 is a flowchart explaining one example of control performed by an ECU according to the first embodiment. In FIG. 1 and FIG. 2, the combination of gear ratios of a main transmission and a damper transmission, to be described later, is different.

In the following description, unless particularly stated, a direction along rotation axis lines X1, X2, X3 is referred to as an axial direction; a direction orthogonal to the rotation axis lines X1, X2, X3, that is, a direction orthogonal to the axial direction is referred to as a radial direction; and a direction about the rotation axis lines X1, X2, X3 is referred to as a circumferential direction. In the radial direction, the rotation axis lines rotation axis lines X1, X2, X3 side is referred to as a radially inner side, and the opposite side is referred to as a radially outer side.

A dynamic damper device 1 of the present embodiment is a so-called dynamic damper (dynamic vibration absorber) that is applied to a vehicle 2 as illustrated in FIG. 1 and FIG. 2 to reduce the vibration using an anti-resonant principle with respect to a resonance point (resonance frequency) of a power train 3 of the vehicle 2. The power train 3 of the vehicle 2 is configured including an engine 4 serving as an internal combustion engine, which is a travelling drive source, a power transmitting device 5 for transmitting the power generated by the engine 4 to a drive wheel 10, and the like. The power transmitting device 5 is configured including a clutch 6, a damper 7, a torque converter (not illustrated), a main transmission 8, a differential gear 9, and the like. The power transmitting device 5 can, for example, gear shift the rotation power from the engine 4 with the main transmission 8 and transmit to the drive wheel 10 of the vehicle 2. The engine 4, the clutch 6, the main transmission 8, and the like are controlled by an ECU 11 serving as a control device.

Therefore, in the vehicle 2, when a crankshaft 4a of the engine 4 is rotatably driven, such drive force is input to the main transmission 8 via the clutch 6, the damper 7, the torque converter (not illustrated), and the like to be gear shifted, and transmitted to each drive wheel 10 via the differential gear 9, and the like, so that each drive wheel 10 rotates enabling forward movement or backward movement. The vehicle 2 is also mounted with a braking device 12 that causes the vehicle 2 to generate a braking force according to a brake operation, which is a brake request operation, performed by the driver. The vehicle 2 is decelerated by the braking force generated by the braking device 12, thus coming to a stop.

The clutch 6 is arranged between the engine 4 and the drive wheel 10, or the engine 4 and the damper 7 herein, in the power transmission system. Various clutches can be used for the clutch 6, and for example, a friction type disc clutch device such as a wet multi-plate clutch, a dry single-plate clutch, and the like can be used. In this case, the clutch 6 is, for example, a hydraulic device that operates by a clutch hydraulic pressure, which is the hydraulic pressure of the working fluid. The clutch 6 can be switched to an engaged state, in which a rotation member 6a on the engine 4 side and a rotation member 6b on the drive wheel 10 side are engaged so that power can be transmitted and in which the engine 4 and the drive wheel 10 are engaged so that power can be transmitted, and a released state in which the engagement is released. The clutch 6 is in a state the rotation member 6a and the rotation member 6b are coupled and the power can be transmitted between the engine 4 and the drive wheel 10 when in the engaged state. The clutch 6 is in a state the rotation member 6a and the rotation member 6b are separated and the power transmission is blocked between the engine 4 and the drive wheel 10 when in the released state. The clutch 6 is in the released state in which the engagement is released when an engagement force for engaging the rotation member 6a and the rotation member 6b is zero, and is in a completely engaged state after a semi-engaged state (slip state) as the engagement force becomes larger. The rotation member 6a is a member that integrally rotates with the crankshaft 4a in this case. The rotation member 6b is a member that integrally rotates with a transmission input shaft (input shaft) 13 by way of the damper 7, and the like.

The main transmission 8 changes the gear ratio (gear shift stage) according to the travelling state of the vehicle 2. The main transmission 8 is arranged on a transmission path for power from the engine 4 to the drive wheel 10 to shift the power of the engine 4 and output the same. The power transmitted to the main transmission 8 is gear shifted at a predetermined gear ratio in the main transmission 8 and transmitted to each drive wheel 10. The main transmission 8 may be a so-called manual transmission (MT), or may be a so-called automatic transmission such as a stepped variable transmission (AT), a continuously variable automatic transmission (CVT), a multi-mode manual transmission (MMT), a sequential manual transmission (SMT), a dual clutch transmission (DCT), and the like. In this case, for example, the main transmission 8 is applied to the automatic transmission, and the operation is controlled by the ECU 11.

More specifically, the main transmission 8 gear shifts the rotation power input from the engine 4 to the transmission input shaft 13 and outputs the same from a transmission output shaft (output shaft) 14. The transmission input shaft 13 is a rotation member to which the rotation power from the engine 4 is input in the main transmission 8. The transmission output shaft 14 is a rotation member that outputs the rotation power toward the drive wheel 10 in the main transmission 8. The transmission input shaft 13 is rotatable with a rotation axis line X1 as the center of rotation when the power from the engine 4 is transmitted. The transmission output shaft 14 can be rotated with a rotation axis line X2 parallel to the rotation axis line X1 as the center of rotation when the gear shifted power from the engine 4 is transmitted. The main transmission 8 includes a plurality of gear shift stages (gear stages) 81, 82, 83, to each of which a predetermined gear ratio is assigned. The main transmission 8 has one of the plurality of gear shift stages 81, 82, 83 selected by a gear shift mechanism 84 configured including a synchronous meshing mechanism, and the like to shift the power input to the transmission input shaft 13 and output the same toward the drive wheel 10 from the transmission output shaft 14 according to the selected gear shift stage 81, 82, 83.

The ECU 11 is an electronic circuit having a well-known microcomputer including a CPU, ROM, RAM, and an interface as a main body. The ECU 11 is input with an electric signal corresponding to various detection results, and the like, and controls the engine 4, the clutch 6, the main transmission 8, the braking device 12, and the like according to the input detection results, and the like. The power transmitting device 5 including the main transmission 8, and the like, and the braking device 12 are hydraulic devices that operate by the pressure (hydraulic pressure) of the working fluid serving as a medium, and the ECU 11 controls the operation thereof through a hydraulic control device, and the like. The ECU 11, for example, controls a throttle device of the engine 4 based on an accelerator opening, vehicle speed, and the like, adjusts the throttle opening of an intake passage, adjusts the intake air amount to control the fuel injection amount in correspondence with such change, and adjusts an amount of mixed air filled in a combustion chamber to control the output of the engine 4. The ECU 11 also controls the hydraulic control device based on the accelerator opening, the vehicle speed, and the like, for example, and controls the operation state of the clutch 6 and the gear shift stage (gear ratio) of the main transmission 8.

The dynamic damper device 1 of the present embodiment is arranged on a rotation shaft of the power transmitting device 5 that rotates when the power from the engine 4 is transmitted, or in this case, the transmission output shaft 14 of the main transmission 8 configuring a drive system in the power train 3. The transmission output shaft 14 has the rotation axis line X2 arranged substantially parallel to a rotation axis line X3 of a damper rotation shaft 15, to be described later.

The dynamic damper device 1 damps (absorbs) and suppresses the vibration when the damper mass vibrates in an opposite phase with respect to the vibration of a specific frequency acting on a damper main body 20 by way of a spring 30 serving as an elastic body from the transmission output shaft 14. That is, the dynamic damper device 1 achieves high damping effect (dynamic damper effect) when the damper mass resonance vibrates and alternatively absorbs the vibration energy to absorb the vibration with respect to the vibration of the specific frequency acting on the damper main body 20.

The dynamic damper device 1 includes the damper main body 20 serving as a dynamic damper, and the ECU 11 serving as a control device for controlling the damper main body 20 to appropriately reduce the vibration. The damper main body 20 can appropriately change the damper properties for the dynamic damper according to the driving state. The dynamic damper device 1 typically changes the damper properties by changing an natural frequency of the damper main body 20 according to the state of the power train 3 by the control of the ECU 11.

The damper main body 20 of the present embodiment includes a damper mass device 60, in which a rotating body 61 (see also FIG. 3) serving as a damper mass is coupled to the transmission output shaft 14 by way of the spring 30, and a damper transmission 40 arranged on a power transmission path between the spring 30 and the rotating body 61. The damper transmission 40 gear shifts the power transmitted to the rotating body 61 at the gear ratio corresponding to the gear ratio of the main transmission 8. The dynamic damper device 1 thus can reduce the rotational fluctuation of the drive system, and for example, enable the use of a driving region having satisfactory efficiency of engine low rotation high load at the time of travelling of the vehicle 2.

Specifically, as illustrated in FIG. 1 and FIG. 2, the damper main body 20 of the present embodiment includes the damper rotation shaft 15, the spring 30, the damper transmission 40, a damper clutch 50 serving as an engagement device, and the damper mass device 60. As illustrated in FIG. 3, the damper mass device 60 includes the rotating body 61 serving as the damper mass, and a variable inertia mass device 62 for variably controlling the inertia mass of the rotating body 61. Furthermore, the variable inertia mass device 62 is configured including a planetary gear mechanism 63 having a plurality of rotating elements that can be differentially rotated and in which the rotating body 61 is arranged on one of a plurality of rotating elements, and a rotation control device 64 for controlling the rotation of the rotating elements of the planetary gear mechanism 63.

The damper mass device 60 has one of the plurality of rotating elements of the planetary gear mechanism 63 serving as an input element, to which the power from the engine 4 or the drive wheel 10 is input, and the other rotating elements serving as rotation controlling elements in the variable inertia mass device 62 using the planetary gear mechanism 63. The damper rotation shaft 15 has the rotation axis line X3 arranged substantially parallel to the rotation axis line X2 of the transmission output shaft 14. The damper rotation shaft 15 can rotate with the rotation axis line X3 as the center of rotation when the power is transmitted.

In the damper main body 20, the planetary gear mechanism 63 of the damper mass device 60 is coupled to the transmission output shaft 14 by way of the spring 30 to be elastically supported. The damper main body 20 thus can have the spring 30 act as a member for adjusting the torsional rigidity of the dynamic damper. The damper main body 20 can also have each rotating element of the planetary gear mechanism 63 and the rotating body 61 act as an inertia mass member for generating an inertia moment in the damper mass, that is, the dynamic damper. In the following description, a case of having the inertia mass of the damper mass to be variable includes a case of having an apparent inertia mass to be variable by varying the rotation of the damper mass, unless particularly stated.

Here, the damper main body 20 has the damper transmission 40, the damper clutch 50, and the entire damper mass device 60 (include rotating body 61, planetary gear mechanism 63, and rotation control device 64) act as the damper mass of the dynamic damper.

In the dynamic damper device 1 of the present embodiment, the rotating body 61 of the damper mass device 60 functions as the damper mass in the damper main body 20, and also functions as a so-called fly wheel that accumulates the transmitted rotation power as inertia energy. The dynamic damper device 1 thus can also use the damper main body 20 as a travelling energy accumulating device of the vehicle 2. That is, the damper mass device 60 uses the rotating body 61 as the damper mass and also as the fly wheel, so that the rotating body 61 can rotate the power is transmitted, and the rotation power transmitted to the rotating body 61 can be accumulated as the inertia energy. The dynamic damper device 1 thus achieves both reduction in vibration and improvement in fuel economy performance.

Each configuration of the dynamic damper device 1 will be hereinafter described in detail with reference to FIG. 1, FIG. 2, and FIG. 3.

The spring 30 elastically supports the rotating body 61, more specifically, a carrier 63C (see FIG. 3), to be described later, which is an input element of the planetary gear mechanism 63, at the transmission output shaft 14. That is, the spring 30 is interposed on the power transmission path between the transmission output shaft 14 and the carrier 63C of the damper mass device 60 to couple the transmission output shaft 14 and the carrier 63C in a relatively rotatable manner.

Here, the spring 30 elastically supports the damper transmission 40, the damper clutch 50, and the damper mass device 60 that function as the damper mass in the damper main body 20 at the transmission output shaft 14. More specifically, the spring 30 is interposed on the power transmission path between the transmission output shaft 14 and the damper transmission 40 to couple the transmission output shaft 14 and a first drive gear 41a and a second drive gear 42a of the damper transmission 40. That is, the rotating body 61 is elastically supported at the transmission output shaft 14 by the spring 30 by way of the carrier 63C of the planetary gear mechanism 63, the damper clutch 50, the damper rotation shaft 15, the damper transmission 40, and the like.

For example, the spring 30 is held in plurals along the circumferential direction by a spring holding mechanism, and the like, which is configured to include various circular ring members, and the like coaxial with the rotation axis line X2, for example. The spring 30 is arranged so that the transmission output shaft 14 is inserted to the radially inner side of the spring holding mechanism.

The power (fluctuation component) transmitted from the engine 4 to the transmission output shaft 14 is input (transmitted) to the first drive gear 41a and the second drive gear 42a of the damper transmission 40 via the spring 30. Meanwhile, the spring 30 is elastically deformed according to the magnitude of the power transmitted between the transmission output shaft 14 and the first drive gear 41a and the second drive gear 42a while being held by the spring holding mechanism.

In the damper transmission 40, the transmission output shaft 14 becomes the input shaft and the damper rotation shaft 15 becomes the output shaft. The damper transmission 40 is configured including a plurality of gear shift stages (gear stages) 41, 42, to each of which a predetermined gear ratio is assigned, and a gear shift mechanism 43.

The gear shift stage 41 is configured including the first drive gear 41a and a first driven gear 41b meshed with the first drive gear 41a. The gear shift stage 42 is configured including the second drive gear 42a and a second driven gear 42b meshed with the second drive gear 42a. The first drive gear 41a and the second drive gear 42a are integrally formed, and are arranged so that the transmission output shaft 14 is inserted on the radially inner side. The first drive gear 41a and the second drive gear 42a are supported in a relatively rotatable manner by the transmission output shaft 14 by way of a bush, and the like in the integrated state. The first drive gear 41a and the second drive gear 42a are coupled to and elastically supported by the transmission output shaft 14 by way of the spring 30, and are relatively rotatable by way of the spring 30 with respect to the transmission output shaft 14.

The first driven gear 41b and the second driven gear 42b are formed as separate bodies, and are arranged so that the damper rotation shaft 15 is inserted on the radially inner side. The first driven gear 41b and the second driven gear 42b are respectively supported in a relatively rotatable manner by the damper rotation shaft 15 by way of a bush, and the like.

The damper transmission 40 has the first driven gear 41b or the second driven gear 42b of one of the plurality of gear shift stages 41, 42 selectively coupled to the damper rotation shaft 15 by the gear shift mechanism 43 configured to include the synchronous meshing mechanism, and the like. For example, when the first driven gear 41b is coupled to the damper rotation shaft 15 by the gear shift mechanism 43 in the damper transmission 40, the second driven gear 42b and the damper rotation shaft 15 are decoupled so that the second driven gear 42b is in an idling state. In this case, the power from the engine 4 is transmitted to the damper rotation shaft 15 through the transmission output shaft 14, the spring 30, the first drive gear 41a, the first driven gear 41b, and the like. On the contrary, when the second driven gear 42b is coupled to the damper rotation shaft 15 by the gear shift mechanism 43 in the damper transmission 40, the first driven gear 41b and the damper rotation shaft 15 are decoupled so that the first driven gear 41b is in the idling state. In this case, the power from the engine 4 is transmitted to the damper rotation shaft 15 through the transmission output shaft 14, the spring 30, the second drive gear 42a, the second driven gear 42b, and the like.

The damper transmission 40 gear shifts the power transmitted through the spring 30 from the transmission output shaft 14 at the predetermined gear ratio corresponding to the gear shift stage 41 and the gear shift stage 42 selected by the gear shift mechanism 43, and transmits the same to the damper rotation shaft 15. The damper transmission 40 outputs the gear shifted power toward the damper mass device 60 from the damper rotation shaft 15.

The damper clutch 50 can be switched to a state in which the transmission output shaft 14 and the damper mass device 60 are engaged so that power can be transmitted and a state in which the engagement is released. The damper clutch 50 of the present embodiment is arranged on the power transmission path between the damper transmission 40 and the damper mass device 60. Various clutches can be used for the damper clutch 50, and for example, a friction type disc clutch device such as a wet multi-plate clutch, a dry single-plate clutch, and the like can be used. The damper clutch 50 is, for example, a hydraulic device that operates by a clutch hydraulic pressure, which is the hydraulic pressure of the working fluid. The damper clutch 50 can be switched to an engaged state, in which a rotation member 50a on the damper transmission 40 side and a rotation member 50b on the damper mass device 60 side are engaged so that power can be transmitted and in which the damper transmission 40 and the damper mass device 60 are engaged so that power can be transmitted, and a released state in which the engagement is released. The damper clutch 50 is in a state the rotation member 50a and the rotation member 50b are coupled and the power can be transmitted between the damper transmission 40, and furthermore, the transmission output shaft 14 and the damper mass device 60 when in the engaged state. The damper clutch 50 is in a state the rotation member 50a and the rotation member 50b are separated and the power transmission is blocked between the damper transmission 40, and furthermore, the transmission output shaft 14 and the damper mass device 60 when in the released state. The damper clutch 50 is in the released state in which the engagement is released when an engagement force for engaging the rotation member 50a and the rotation member 50b is zero, and is in a completely engaged state after a half-engaged state (slip state) as the engagement force becomes larger. The rotation member 50a is a member that integrally rotates with the damper rotation shaft 15 in this case. The rotation member 50b is a member that integrally rotates with the carrier 63C, which is the input element of the planetary gear mechanism 63. In the present embodiment, the damper clutch 50 is basically in the engaged state.

As described above, the damper mass device 60 includes the rotating body 61 and the variable inertia mass device 62 (see FIG. 3), as described above. The variable inertia mass device 62 typically variably controls the inertia mass of the planetary gear mechanism 63 and the rotating body 61 coupled thereto, and is configured including the planetary gear mechanism 63 and the rotation control device 64, as described above. The damper mass device 60 of the present embodiment can accumulate the inertia energy to the rotating body 61 or discharge the inertia energy from the rotating body 61 by having the rotation control device 64 configuring the variable inertia mass device 62 control the rotation of the rotating element of the planetary gear mechanism 63.

The planetary gear mechanism 63 is configured including a plurality of rotating elements that can differentially rotate with each other, where the center of rotation of each rotating element is arranged coaxially with the rotation axis line X3. The planetary gear mechanism 63 is a so-called single pinion planetary gear mechanism, and is configured including a sun gear 63S, a ring gear 63R, and the carrier 63C for the rotating elements. The sun gear 63S is an external gear. The ring gear 63R is an internal gear arranged coaxially with the sun gear 63S. The carrier 63C holds a plurality of pinion gears 63P, which meshes with both the sun gear 63S and the ring gear 63R herein, in a rotating and revolving manner. In the planetary gear mechanism 63 of the present embodiment, the carrier 63C is a first rotating element and corresponds to the input element, the ring gear 63R is a second rotating element and corresponds to the rotation controlling element, and the sun gear 63S is a third rotating element and corresponds to a fly wheel element in which the rotating body 61 is arranged.

The carrier 63C is formed to a circular ring plate shape, and supports the pinion gear 63P, which is an external gear, at a pinion shaft in a manner capable of rotating and revolving. The carrier 63C configures the input member of the variable inertia mass device 62, and moreover, the planetary gear mechanism 63. The carrier 63C is coupled in a relatively rotatable manner with the transmission output shaft 14 by way of the damper clutch 50, the damper rotation shaft 15, the damper transmission 40, the spring 30, and the like. The power transmitted from the engine 4 to the transmission output shaft 14 is transmitted (input) to the carrier 63C via the spring 30, the damper transmission 40, the damper rotation shaft 15, and the damper clutch 50. The ring gear 63R is formed to a circular ring plate shape, and has gears formed on the inner circumferential surface. The sun gear 63S is formed to a cylindrical shape and has gears formed on the outer circumferential surface. The ring gear 63R is coupled with a motor 65 of the rotation control device 64, and the sun gear 63S is coupled with the rotating body 61.

The rotating body 61 is formed to a disc plate shape. The rotating body 61 is coupled in an integrally rotatable manner with respect to the sun gear 63S with the rotation axis line X3 as the center of rotation.

The rotation control device 64 is configured including the motor 65 serving as a speed control device, a battery 66, and the like as a device for controlling the rotation of the rotating element of the planetary gear mechanism 63. The motor 65 is coupled to the ring gear 63R to control the rotation of the ring gear 63R. The motor 65 includes a stator 65S serving as a stator and a rotor 65R serving as a rotor. The stator 65S is fixed to the case, and the like. The rotor 65R is arranged on the radially inner side of the stator 65S, and is coupled to the ring gear 63R in an integrally rotatable manner. The motor 65 is a rotating electrical machine having both a function (powering function) serving as an electrical motor for converting the power supplied from the battery 66 through an inverter, and the like to a mechanical power, and a function (regenerating function) serving as a power generator for converting the input mechanical power to power and charging the battery 66 through the inverter, and the like. The motor 65 can control the rotation (speed) of the ring gear 63R by rotatably driving the rotor 65R. The drive of the motor 65 is controlled by the ECU 11.

The variable inertia mass device 62 configured as above variably controls the apparent inertia mass of the planetary gear mechanism 63 including the rotating body 61, which is the damper mass, as will be described later, when the ECU 11 executes the drive control of the motor 65 of the rotation control device 64.

The ECU 11 is input with an electric signal corresponding to the detection results detected from various sensors such as an accelerator opening sensor 70, a throttle opening sensor 71, a vehicle speed sensor 72, an engine speed sensor 73, an input shaft rotation number sensor 74, a motor rotation number sensor 75, a steering angle sensor 76, and the like. The accelerator opening sensor 70 detects the accelerator opening, which is the operating amount of the accelerator pedal (accelerator operating amount) performed by the driver. The throttle opening sensor 71 detects the throttle opening of the engine 4. The vehicle speed sensor 72 detects the vehicle speed, which is the travelling speed of the vehicle 2. The engine speed sensor 73 detects the engine speed of the engine 4. The input shaft rotation number sensor 74 detects the input shaft rotation number of the transmission input shaft 13 of the main transmission 8. The motor rotation number sensor 75 detects the motor rotation number of the motor 65. The steering angle sensor 76 detects the steering angle of the handle mounted on the vehicle 2.

The ECU 11 controls the engine 4, the main transmission 8, and the like, and controls the drive of the damper transmission 40, the damper clutch 50, and the motor 65 of the rotation control device 64 according to the input detection results. Here, the damper transmission 40 and the damper clutch 50 are hydraulic devices that operate by the pressure (hydraulic pressure) of the working fluid serving as a medium, and the ECU 11 controls such operations through the hydraulic control device, and the like. The ECU 11 can detect ON/OFF of the acceleration operation, which is an acceleration request operation, on the vehicle 2 by the driver based on the detection result of the accelerator opening sensor 70. The ECU 11 of the present embodiment is used as both a first control device and a fourth control device.

When the damper mass vibrates at an opposite phase with respect to the vibration of a specific frequency acting on the damper transmission 40, the damper clutch 50, the damper mass device 60, and the like serving as the damper mass through the spring 30 from the transmission output shaft 14, the dynamic damper device 1 configured as above cancels such vibration and damps (absorbs) and suppresses the vibration. The dynamic damper device 1 thus can suppress the vibration caused by an engine explosion first-order that occurred in the power train 3, for example, and can achieve reduction in vibration noise and improvement in fuel economy.

In this case, the dynamic damper device 1 performs the damping control when the ECU 11 controls the drive of the motor 65 of the rotation control device 64 to control the rotation of the planetary gear mechanism 63, so that the vibration of the opposite phase in the damper main body 20 can be appropriately set according to the vibration generated in the power train 3, and the vibration can be appropriately reduced in a driving region of a wider range.

In other words, in the dynamic damper device 1, the ECU 11 controls the drive of the motor 65 to variably control the rotation of the ring gear 63R. Thus, the dynamic damper device 1 performs the inertia mass control of variably controlling the apparent inertia mass of the damper mass by varying the rotation of the rotating element such as the ring gear 63R, the sun gear 63S, and the like, and the rotating body 61 of the planetary gear mechanism 63, and varying the inertia force acting on the damper mass including the ring gear 63R, the sun gear 63S, the rotating body 61, and the like. For example, the dynamic damper device 1 obtains effects similar to when the apparent inertia mass of the damper mass is increased and the actual inertia mass is increased by increasing the rotation speed of the rotating body 61, which is a relatively large damper mass. Using such fact, the dynamic damper device 1 can change the resonance point with respect to a fixed spring constant, and thus can change the natural frequency for the damper main body 20 and change the damper properties.

The natural frequency fa of the damper main body 20 can be expressed with the following mathematical equation (1) using, for example, a spring constant Kd of the spring 30 and the total inertia mass Ia of the damper mass of the damper main body 20.

fa=(√(Kd/Ia))/2π (1)

The total inertia mass Ia includes, for example, actual inertia mass, total inertia mass speed term, total inertia mass torque term, and the like of the damper mass (damper transmission 40, damper clutch 50, damper mass device 60) of the damper main body 20. The total inertia mass speed term is the apparent inertia mass obtained by varying the rotation speed of each rotating element and the rotating body 61 in the entire planetary gear mechanism 63. In other words, the total inertia mass speed term is the apparent inertia mass in the entire planetary gear mechanism 63 by the rotation speed control of the motor 65. The total inertia mass torque term is the apparent inertia mass by the torque that is acted when changing the rotation speed of each rotating element in the entire planetary gear mechanism 63. In other words, the total inertia mass torque term is the apparent inertia mass in the entire planetary gear mechanism 63 by the torque control of the motor 65.

Therefore, the dynamic damper device 1 can appropriately adjust the natural frequency fa of the damper main body 20 according to the vibration generated in the power train 3 when the ECU 11 controls the drive of the motor 65 and executes the rotation control of the planetary gear mechanism 63 to adjust the total inertia mass Ia. For example, the ECU 11 controls the drive of the motor 65 based on a target control amount corresponding to the vibration mode defined by the number of resonance points, the resonance frequency, and the like of the power train 3 that change according to the current engine speed, the engine torque, the gear shift stage, and the like. For example, the target control amount is the target motor rotation number that can realize the natural frequency fa capable of reducing the vibration using the anti-resonant principle in the damper main body 20 with respect to the power train 3 that vibrates in each vibration mode.

As a result, the dynamic damper device 1 can adjust the natural frequency fa of the damper main body 20 to an appropriate natural frequency fa to change to the appropriate damper property, and can perform the control so that the efficiency and the vibration noise of the power train 3 become optimum even when the resonance point (resonance frequency) in the power train 3 is changed. In the vehicle 2, for example, the vibration can be suppressed by turning OFF (released state) the lockup clutch of the torque converter, but in such a case, the fuel economy may degrade. However, according to the dynamic damper device 1, the vibration can be appropriately suppressed while suppressing the degradation in fuel economy caused by turning OFF the lockup clutch.

In the dynamic damper device 1 of the present embodiment, the damper transmission 40 gear shifts the power transmitted to the damper mass device 60 at the gear ratio corresponding to the gear ratio of the main transmission 8, so that appropriate damping control corresponding to the gear shift situation of the main transmission 8 can be carried out, for example, when the gear ratio (gear shift stage) of the main transmission 8 is changed.

As described above, the main transmission 8 includes a plurality of gear shift stages (gear stages) 81, 82, 83 respectively assigned with a predetermined gear ratio, and the damper transmission 40 includes a plurality of gear shift stages 41, 42 respectively assigned with a predetermined gear ratio. The damper transmission 40 has the gear ratio of each gear shift stage 41, 42 set according to the gear ratio of the main transmission 8.

The gear ratio of the damper transmission 40 may not correspond to all the gear ratios of the main transmission 8. The damper transmission 40, for example, merely needs to have a gear ratio corresponding to the driving region in which the damping control by the dynamic damper device 1 is required, and typically, a gear shift stage corresponding to the gear shift stage on the high side of the main transmission 8. The damper transmission 40 of the present embodiment includes the gear shift stages 41, 42 so as to correspond to the gear shift stages 82, 83 on the high side of the main transmission 8 where there are relatively many steady travelling states. For example, the damper transmission 40 may not include the gear ratio corresponding to the driving region in which the lockup OFF is obtained and the torque converter can transmit fluid such as at the time of starting of the vehicle 2, and the like, and typically, the gear shift stage corresponding to the gear shift stage 81 (first speed), and the like of the main transmission 8.

In the damper transmission 40 of the present embodiment, the gear shift stage 41 corresponds to the gear shift stage 82 of the main transmission 8, and the gear shift stage 42 corresponds to the gear shift stage 83 of the main transmission 8. The gear shift stage 41 and the gear shift stage 82, as well as the gear shift stage 42 and the gear shift stage 83 are combined such that a speed ratio S of the main transmission 7, and a speed ratio Z of the damper transmission 40 satisfy [S·(1/Z)=constant], for example. Furthermore, the actual inertia mass of the damper mass, the spring constant Kd of the spring 30, and the like are set to satisfy the following mathematical equations (2) and (3), for example, in each combination of the gear shift stage 41 and the gear shift stage 82, and the gear shift stage 42 and the gear shift stage 83.

(Kt/Mta)=(Kd/Mda) (2)

(Kt/Mtb)=(Kd/Mdb) (3)

In the mathematical equations (2) and (3), “Kt” represents the spring constant of the damper 7. “Kd” represents the spring constant of the spring 30. “Mta” represents the drive system inertia mass on the downstream side (i.e., drive wheel 10 side) in the power transmitting direction of the damper 7 in a state the gear shift stage 83 is selected in the main transmission 8. “Mda” represents the total inertia mass (Ia) of the damper mass on the downstream side in the power transmitting direction of the spring 30 in a state the gear shift stage 42 is selected in the damper transmission 40 and in a state the rotation number of the rotating body 61 (sun gear 63S) is substantially zero. “Mtb” represents the drive system inertia mass on the downstream in the power transmitting direction of the damper 7 in a state the gear shift stage 82 is selected in the main transmission 8. “Mdb” represents the total inertia mass (Ia) of the damper mass on the downstream in the power transmitting direction of the spring 30 in a state the gear shift stage 41 is selected in the damper transmission 40 and in a state the rotation number of the rotating body 61 (sun gear 63S) is substantially zero.

The ECU 11 typically performs the gear shift of the damper transmission 40 according to the gear shift of the main transmission 8 to change the gear ratio of the damper transmission 40. In other words, when the gear ratio of the main transmission 8 is changed, the gear ratio of the damper transmission 40 is changed in accordance therewith. As illustrated in FIG. 1, in the damper transmission 40, the gear shift stage 42 is selected and the power to be transmitted to the damper mass device 60 is gear shifted by the gear shift stage 42 when the gear shift stage 83 is selected in the main transmission 8 and the power from the engine 4 is gear shifted by the gear shift stage 83. Similarly, as illustrated in FIG. 2, in the damper transmission 40, the gear shift stage 41 is selected and the power to be transmitted to the damper mass device 60 is gear shifted by the gear shift stage 41 when the gear shift stage 82 is selected in the main transmission 8 and the power from the engine 4 is gear shifted by the gear shift stage 82. As a result, the damper transmission 40 is set with the gear ratio corresponding to the current gear ratio of the main transmission 8, and can gear shift the power transmitted to the damper mass device 60 at the gear ratio corresponding to the current gear ratio of the main transmission 8.

Therefore, in the dynamic damper device 1, even if the resonance point (resonance frequency) of the power train 3 is greatly changed according to the gear shift of the main transmission 8, the gear ratio (gear shift stage) of the damper transmission 40 is changed in accordance therewith, and the power to be transmitted to the damper mass device 60 can be gear shifted at the gear ratio corresponding to the current gear ratio of the main transmission 8 in the damper transmission 40. As a result, even if the gear ratio of the main transmission 8 is changed, and the rotation number of the power input from the transmission output shaft 14 to the damper main body 20 is greatly fluctuated accompanying therewith, for example, the dynamic damper device 1 can adjust the natural frequency fa of the damper main body 20 to an appropriate natural frequency fa and change to the appropriate damper property since the damper transmission 40 gear shifts the power to be transmitted to the damper mass device 60 accordingly. Therefore, the dynamic damper device 1 is the dynamic damper for reducing the vibration using the anti-resonant principle, and can easily perform the highly accurate damping control in correspondence with the fluctuation of the resonance point of the power train 3 corresponding to the gear shift of the main transmission 8, and can suppress the resonance point from greatly fluctuating and exceeding the control range of the dynamic damper device 1. Therefore, the dynamic damper device 1 can suppress the enlargement of the device and appropriately reduce the vibration in the driving region of wide range.

As described above, the damper mass device 60 of the present embodiment accumulates the rotation power transmitted to the rotating body 61 as inertia energy.

The damper mass device 60 ensures the accumulation capacity of the inertia energy by having a state in which the rotation number of the rotating body 61 (sun gear 63S) is substantially zero as a basic optimum resonance state. In other words, in the damper main body 20 of the present embodiment, the actual inertia mass of the damper mass and the spring constant Kd of the spring 30 are adjusted and the natural frequency and the optimum resonance point of the damper main body 20 are adjusted to cancel and damp the vibration generated in the power train 3, in a state the rotation number of the rotating body 61 is substantially zero and the apparent inertia mass of the rotating body 61 is relatively small.

The carrier 63C, the ring gear 63R, and the sun gear 63S of the planetary gear mechanism 63 operate at the rotation speed (corresponding to rotation number) based on the collinear view illustrated in FIG. 4. FIG. 4 illustrates the relative relationship of the rotation speed of each rotating element of the planetary gear mechanism 63 with a straight line, and is a speed diagram in which the speed ratio of each rotating element is arranged, where the vertical axis indicates the speed ratio (corresponding to relative rotation number ratio) of the respective rotation of the sun gear 63S, the carrier 63C, and the ring gear 63R, and the respective interval along the horizontal axis is the interval corresponding to a tooth number ratio of the ring gear 63R and the sun gear 63S. In FIG. 4, the carrier 63C, which is the input rotating element, is assumed as a reference, and the speed ratio of the rotation of the carrier 63C is assumed as one. A gear ratio ρ illustrated in FIG. 4 is a gear ratio of the planetary gear mechanism 63. In other words, assuming the interval of the sun gear 63S and the carrier 63C is “1”, the interval of the carrier 63C and the ring gear 63R corresponds to the gear ratio ρ.

The damper mass device 60 assumes the state in which the rotation number of the rotating body 61 (sun gear 63S) is substantially zero as the basic optimum resonance state, as illustrated with a solid line L11. The ECU 11 controls the drive of the motor 65 of the rotation control device 64 in the basic optimum resonance state, and raises the motor rotation number to adjust the rotation number of the ring gear 63R toward the increasing side so that the rotation number of the rotating body 61 becomes substantially zero. The basic optimum resonance state of the damper mass device 60 is the state in which the inertia energy is not accumulated in the rotating body 61. In other words, in a state of before the accumulation of the inertia energy by the rotating body 61, the variable inertia mass device 62 relatively reduces the apparent inertia mass of the rotating body 61 compared to the state of after the accumulation of the inertia energy by the rotating body 61. Thus, the damper mass device 60 ensures the accumulation capacity (accumulation margin) of the inertia energy in the rotating body 61. The ECU 11 controls the drive of the motor 65 to have the damper mass device 60 in the basic optimum resonance state when the gear shift stages 81, 82, 83 of the main transmission 8 and the gear shift stages 41, 42 of the damper transmission 40 are selected in the above combination. The damper clutch 50 is in the engaged state in the basic optimum resonance state.

As described above, in the damper main body 20, the actual inertia mass of the damper mass and the spring constant Kd of the spring 30 are adjusted to cancel out and damp the vibration generated in the power train 3 in the basic optimum resonance state of the damper mass device 60. The dynamic damper device 1 achieves high damping effect, as described above, at the time of acceleration of the vehicle 2, and the like, and for example, and realizes an extremely quiet travelling in the vehicle 2.

The ECU 11 controls the damper mass device 60, and accumulates the inertia energy (rotational kinetic energy) in the rotating body 61 at the time of non-gear shift operation of the main transmission 8 (state in which the gear ratio is not changed) and in a state the acceleration request operation on the vehicle 2 is canceled, that is, when the acceleration operation is in the OFF state. The ECU 11 typically controls the drive of the motor 65 and lowers the motor rotation number, as illustrated with a dotted line L12 with respect to the solid line L11 in FIG. 4, when the throttle of the engine 4 is closed with the acceleration operation in the OFF state so that the vehicle 2 travels through inertia, or when the brake operation (brake request operation) is turned ON so that the vehicle 2 performs deceleration travelling. The ECU 11 lowers the motor rotation number to adjust the rotation number of the ring gear 63R toward the speed reducing side, and raises the rotation numbers of the sun gear 63S and the rotating body 61. That is, the ECU 11 controls the rotation control device 64 of the damper mass device 60 to raise the rotation number of the rotating body 61 when accumulating the inertia energy in the rotating body 61. Furthermore, when accumulating the inertia energy in the rotating body 61, the ECU 11 uses the motor 65 as a power generator and brake (power generating) controls the motor 65 to lower the motor rotation number and raise the rotation number of the rotating body 61. In this case, the damper clutch 50 is in the engaged state.

In this case, when the vehicle 2 travels through inertia or performs deceleration travelling, the damper mass device 60 has the rotation power input from the drive wheel 10 side to the carrier 63C through the differential gear 9, the transmission output shaft 14, the spring 30, the damper transmission 40, the damper rotation shaft 15, the damper clutch 50, and the like. The damper mass device 60 can accumulate the rotation power transmitted from the carrier 63C to the rotating body 61 as the inertia energy in the rotating body 61 with the rise in the rotation number of the rotating body 61 described above. In other words, the dynamic damper device 1 raises the rotation number of the rotating body 61 to enable idle running by the rotation power transmitted from the drive wheel 10 side to the rotating body 61 constituting the inertia mass of the dynamic damper when the vehicle 2 travels through inertia or deceleration travels, so that the kinetic (travelling) energy of the vehicle 2 can be collected and accumulated in the rotating body 61. Furthermore, the damper mass device 60 accumulates the inertia energy (kinetic energy) in the rotating body 61 and generates and regenerates power by the motor 65 as a whole to convert the kinetic energy to the electric energy and accumulate the same in the battery 66, whereby greater amount of energy can be accumulated. In this case, the vehicle 2 causes the rotation resistance (negative rotation force) by the inertia of the rotating body 61 to act on the drive wheel 10 so that the braking force generates at the drive wheel 10 of the vehicle 2, whereby the vehicle 2 decelerates at the desired deceleration.

The ECU 11 controls the damper mass device 60 to discharge the inertia energy accumulated in the rotating body 61 in a state the acceleration request operation on the vehicle 2 is made, that is, when the acceleration operation is in the ON state. The ECU 11 typically controls the drive of the motor 65 to raise the motor rotation number when the acceleration operation is in the ON state, and the throttle of the engine 4 is opened so that the vehicle 2 performs acceleration travelling. The ECU 11 raises the motor rotation number to adjust the rotation number of the ring gear 63R toward the speed increasing side, and lowers the rotation numbers of the sun gear 63S and the rotating body 61 to obtain the state in which the rotation number of the rotating body 61 is substantially zero, that is, the optimum resonance state. That is, the ECU 11 controls the rotation control device 64 of the damper mass device 60 to lower the rotation number of the rotating body 61 and to have the damper mass device 60 in the optimum resonance state when discharging the inertia energy from the rotating body 61. Furthermore, the ECU 11 uses the motor 65 as the electric motor and drive controls the motor 65 to raise the motor rotation number and lower the rotation number of the rotating body 61 when discharging the inertia energy from the rotating body 61. In this case, the damper clutch 50 is in the engaged state.

The damper mass device 60 discharges the inertia energy accumulated in the rotating body 61 as the rotation power and outputs from the carrier 63C with the lowering of the rotation number of the rotating body 61. The rotation power output from the carrier 63C is transmitted to the drive wheel 10 through the damper clutch 50, the damper rotation shaft 15, the damper transmission 40, the spring 30, the transmission output shaft (output shaft) 14, the differential gear 9, and the like. In other words, the dynamic damper device 1 discharges the inertia energy from the rotating body 61 constituting the inertia mass of the dynamic damper at the time of acceleration travelling of the vehicle 2, and the like, and can drive the drive wheel 10 by the rotation power transmitted from the rotating body 61 to the drive wheel 10. Furthermore, the damper mass device 60 can, as a whole, discharge the inertia energy from the rotating body 61, and convert the electric energy accumulated in the battery 66 to the kinetic energy to discharge the same when the motor 65 is driven and powered. In this case, the vehicle 2 generates the drive force by acting the rotation power from the rotating body 61 and the motor 65 on the drive wheel 10, thereby accelerating the vehicle 2.

In this case, the ECU 11 preferences the discharging of the energy (kinetic energy accumulated in the rotating body 61, and the electric energy accumulated in the battery 66) accumulated in the damper mass device 60 including the rotating body 61 over the generation of power by the engine 4. That is, the ECU 11 accelerates the vehicle 2 preferentially using the rotation power from the rotating body 61 in a state the inertia energy is accumulated as the travelling power at the time of acceleration travelling of the vehicle 2. The ECU 11 controls the output of the engine 4 after returning to a state in which the rotation number of the rotating body 61 is substantially zero, that is, after the damper mass device 60 is returned to the optimum resonance state, and accelerates the vehicle 2 using the power by the engine 4 as the travelling power. The dynamic damper device 1 can thereby improve the fuel economy performance.

The ECU 11 also controls the damper mass device 60 and discharges the inertia energy accumulated in the rotating body 61 even in the gear shift operation of the main transmission 8. Typically, the ECU 11 uses the motor 65 as an electric motor and controls the drive of the motor 65 to raise the motor rotation number before performing the gear shift operation of actually changing the gear shift stage when a gear shift instruction of the main transmission 8 is made based on the accelerator opening, the vehicle speed, and the like. The ECU 11 raises the motor rotation number to adjust the rotation number of the ring gear 63R toward the speed increasing side, and lowers the rotation numbers of the sun gear 63S and the rotating body 61 to discharge the inertia energy and to obtain a state in which the rotation number of the rotating body 61 is substantially zero, that is, the optimum resonance state. The ECU 11 performs the gear shift operation of actually changing the gear shift stage after the damper mass device 60 is returned to the optimum resonance state.

According to this, the dynamic damper device 1 can ensure the accumulation capacity of the inertia energy in the rotating body 61 by returning the damper mass device 60 to the optimum resonance state in advance before the main transmission 8 actually performs the gear shift operation. Furthermore, the dynamic damper device 1 can obtain a state in which the damper main body 20 can have high damping effect before the gear shift operation by returning the damper mass device 60 to the optimum resonance state before the main transmission 8 actually performs the gear shift operation.

Therefore, the dynamic damper device 1 configured as above can achieve both reduction in vibration and improvement in fuel economy performance by appropriately using according to purpose, the function of the dynamic damper of the damper main body 20 and the function of the travelling energy accumulating device of the vehicle 2 according to the state of the vehicle 2, for example. In other words, the dynamic damper device 1 can have the damper main body 20 reduce a so-called NVH (Noise-Vibration-Harshness) as the dynamic damper in a driving state at the time of high output, and the like of the engine 4, for example. In the dynamic damper device 1, the damper main body 20 can accumulate the energy (inertia (kinetic) energy, electric energy) as the energy accumulating device and appropriately discharge the accumulated energy in cooperation with the output of the engine 4 in the driving region in which the engine output at the time of inertia travelling, at the time of deceleration travelling, and the like of the vehicle 2 is small or substantially zero.

The dynamic damper device 1 can separate the damper mass device 60 from the drive system when the ECU 11 controls the damper clutch 50 to a released state according to the state of the vehicle 2. The dynamic damper device 1 thus can reduce the inertia mass of the drive system as necessary and for example, can enhance the acceleration property of the vehicle 2 when the damping by the damper main body 20 is unnecessary, and the like.

One example of control performed by the ECU 11 will now be described with reference to the flowchart of FIG. 5. The control routines are repeatedly executed at a control period of a few ms to a few dozen ms (hereinafter the same).

First, the ECU 11 acquires the vehicle information based on the detection results of various sensors (ST1). The ECU 11, for example, acquires the vehicle information based on the detection results of the accelerator opening sensor 70, the throttle opening sensor 71, the engine speed sensor 73, the vehicle speed sensor 72, the steering angle sensor 76, and the like, the operation states of the torque converter and the main transmission 8, and the like as well as. The ECU 11, for example, acquires information associated with the current gear shift stage of the main transmission 8, the throttle opening (accelerator opening), the engine speed, the lockup state, the vehicle speed, the steering angle of the steering wheel, and the like for the vehicle information.

The ECU 11 then carries out the gear shift determination of the main transmission 8 using the gear shift map (not illustrated) based on the vehicle information detected in ST1, and determines whether or not a gear shift instruction is issued (ST2).

When determining that the gear shift instruction is issued (ST2: Yes), the ECU 11 determines whether or not the fly wheel energy, that is, the inertia energy accumulated in the rotating body 61 is zero (ST3). For example, the ECU 11 can determine whether or not the fly wheel energy is zero by determining whether or not the rotation number of the rotating body 61 is zero based on the detection results of the motor rotation number sensor 75, and the like. The ECU 11 can determine that the fly wheel energy is zero when determining that the rotation number of the rotating body 61 is zero. The ECU 11 can determine that the fly wheel energy is not zero when determining that the rotation number of the rotating body 61 is not zero.

When determining that the fly wheel energy (inertia energy accumulated in the rotating body 61) is zero (ST3: Yes), in other words, when determining that the damper mass device 60 is in the basic optimum resonance state, the ECU 11 controls the main transmission 8 to perform the gear shift operation of actually changing the gear shift stage. In this case, the ECU 11 controls the damper transmission 40 to perform the gear shift operation synchronously in correspondence with the gear shift operation of the main transmission 8 (ST4) so that the combination of the gear shift stage 82, 83 of the main transmission 8 and the gear shift stage 41, 42 of the damper transmission 40 becomes an appropriate combination described above, terminates the current control period, and proceeds to the next control period. In this case, the ECU 11 preferably starts and ends the change of the gear ratio of the damper transmission 40 within a period from the start to the end of the gear shift operation of the main transmission 8. The dynamic damper device 1 thus causes the switching shock generated when changing the gear ratio (gear shift stage) in the damper transmission 40 to be less likely to be felt by the driver physically, and for example, the driveability can be suppressed from degrading.

When determining that the fly wheel energy (inertia energy accumulated in the rotating body 61) is not zero (ST3: No), in other words, when determining that the damper mass device 60 is not in the basic optimum resonance state, the ECU 11 executes fly wheel energy zero control (ST5), and proceeds to ST4 after having the fly wheel energy as zero. For the fly wheel energy zero control, the ECU 11 uses the motor 65 as the electric motor, controls the drive of the motor 65, raises the motor rotation number, adjusts the rotation number of the ring gear 63R toward the speed increasing side, lowers the rotation numbers of the sun gear 63S and the rotating body 61, and discharges the inertia energy to obtain the optimum resonance state in which the rotation number of the rotating body 61 is substantially zero.

When determining that the gear shift instruction is not made in ST2 (ST2: No), the ECU 11 determines whether or not the throttle of the engine 4 is in the ON state, that is, whether or not the acceleration operation is in the ON state and the throttle of the engine 4 is opened (ST6) based on the vehicle information detected in ST1.

When determining that the throttle of the engine 4 is in the ON state (ST6: Yes), that is, when determining that the acceleration operation is in the ON state and the throttle of the engine 4 is opened, the ECU 11 executes the fly wheel energy zero control (ST7), terminates the current control period after having the fly wheel energy as zero, and proceeds to the next control period. The fly wheel energy zero control herein is the control similar to the fly wheel energy zero control in ST5 described above, and thus the detailed description will be omitted.

When determining that the throttle of the engine 4 is in the OFF state (ST6: No), that is, when determining that the acceleration operation is in the OFF state and the throttle of the engine 4 is closed, the ECU 11 executes fly wheel energy accumulation control (ST8), terminates the current control period, and proceeds to the next control period. In this case, for the fly wheel energy accumulation control, the ECU 11 uses the motor 65 as the power generator and brake controls the motor 65, lowers the motor rotation number, adjusts the rotation number of the ring gear 63R toward the speed reducing side, raises the rotation numbers of the sun gear 63S and the rotating body 61, and accumulates the rotation power transmitted to the rotating body 61 as the inertia energy in the rotating body 61. The damper mass device 60 generates and regenerates the power by the motor 65, so that the kinetic energy can be converted to the electric energy and accumulated in the battery 66. In this case, the dynamic damper device 1 can use the rotation resistance of the rotating body 61 for the deceleration required on the vehicle 2 by the driver (driver desiring deceleration).

According to the dynamic damper device 1 of the embodiment described above, the damper mass device 60 and the damper transmission 40 are arranged. The damper mass device 60 has the rotating body 61 coupled by way of the spring 30 to the transmission output shaft 14 of the power transmitting device 5 that can gear shift the rotation power by the main transmission 8 and transmit power to the drive wheel 10 of the vehicle 2. The damper transmission 40 is arranged on the power transmission path between the spring 30 and the rotating body 61 to shift the rotation power transmitted to the rotating body 61 at the gear ratio corresponding to the gear ratio of the main transmission 8. The damper mass device 60 then can accumulate the rotation power transmitted to the rotating body 61 as the inertia energy.

Therefore, the dynamic damper device 1 can appropriately reduce the vibration even if the gear ratio of the main transmission 8 is changed. As a result, the dynamic damper device 1 can reduce the so-called NVH. The dynamic damper device 1 can also achieve both reduction in vibration and improvement in fuel economy performance by using according to purpose, the function of the dynamic damper of the damper main body 20 and the function of the travelling energy accumulating device of the vehicle 2 according to the state of the vehicle 2. The dynamic damper device 1 thus can suppress enlargement of the device, increase in weight, increase in manufacturing cost, and the like, and furthermore, achieve both reduction in vibration and improvement in fuel economy performance.

In the description made above, the damper main body 20 has been described to include the damper clutch 50, but is not limited thereto. The damper main body 20 can use the gear shift mechanism 43 of the damper transmission 40 in place of the damper clutch 50 as an engagement device that can be switched to the state in which the power can be transmitted between the transmission output shaft 14 and the damper mass device 60 and the state in which the engagement is released. The gear shift mechanism 43, for example, can decouple the first driven gear 41b, the second driven gear 42b, and the damper rotation shaft 15 to have both the first driven gear 41b and the second driven gear 42b in the idle running state, thus obtaining a state in which the engagement of the transmission output shaft 14 and the damper mass device 60 is released. The damper main body 20 may have a configuration of not including the engagement device itself.

### Second Embodiment

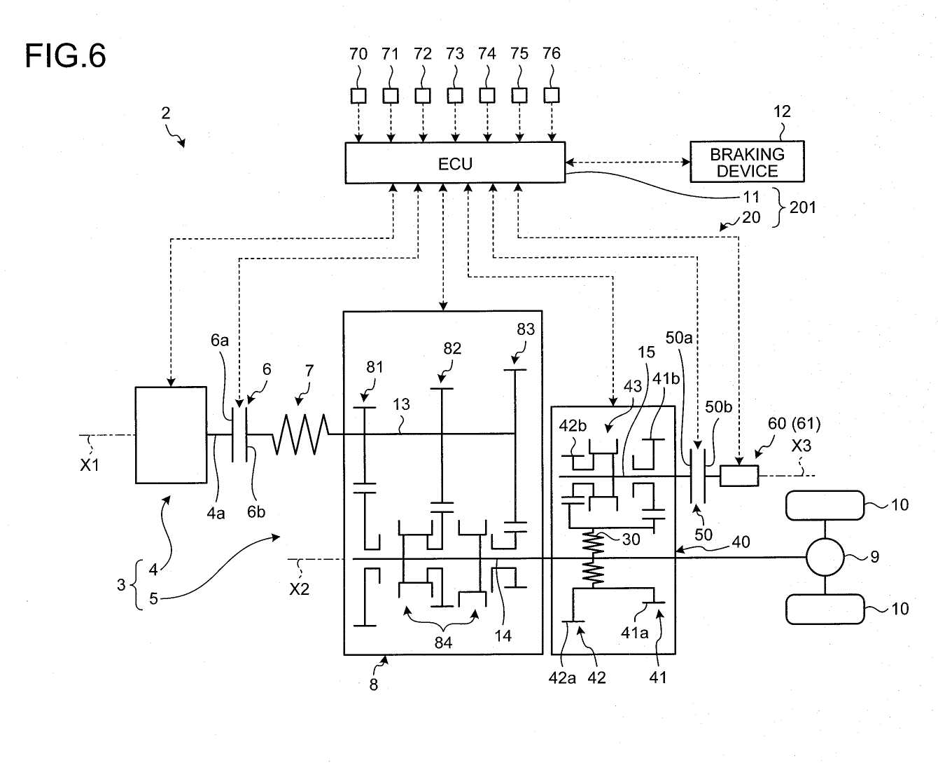

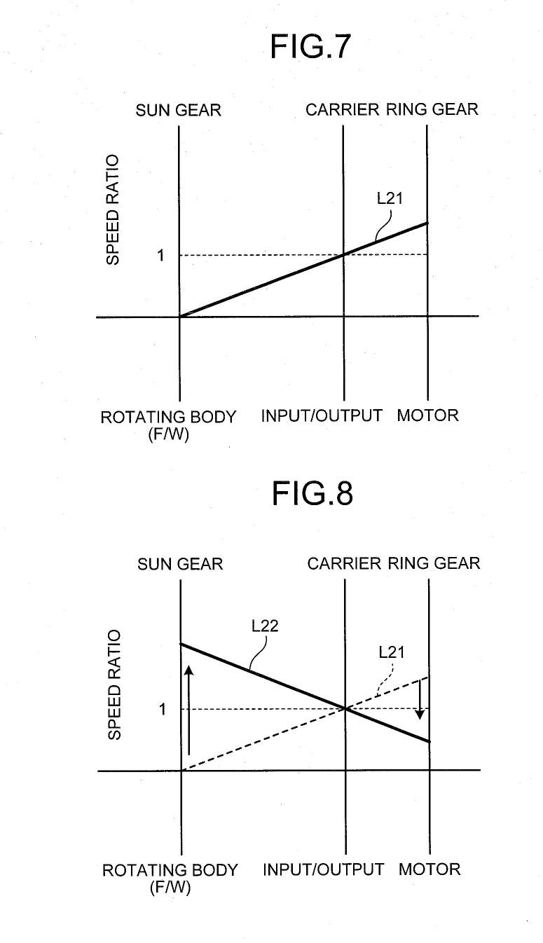

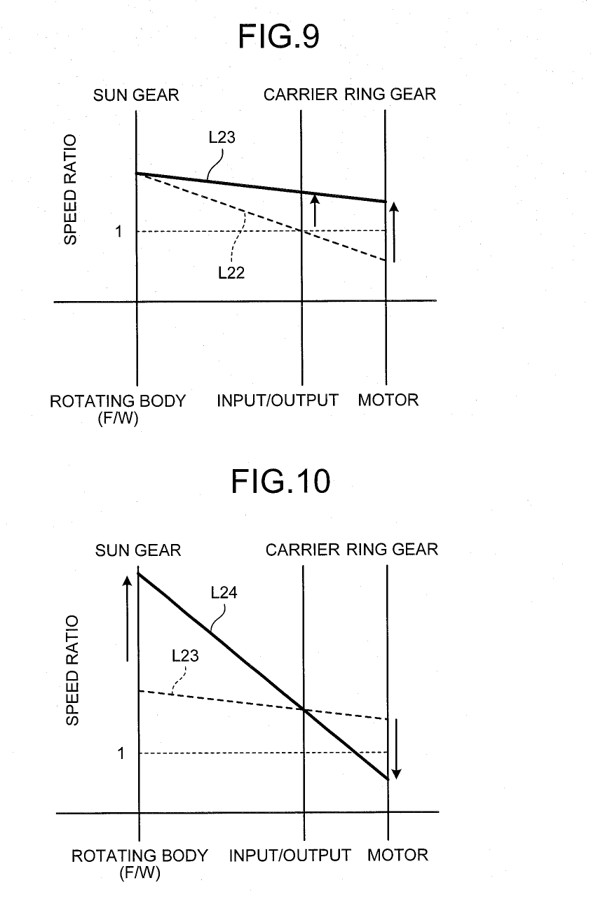

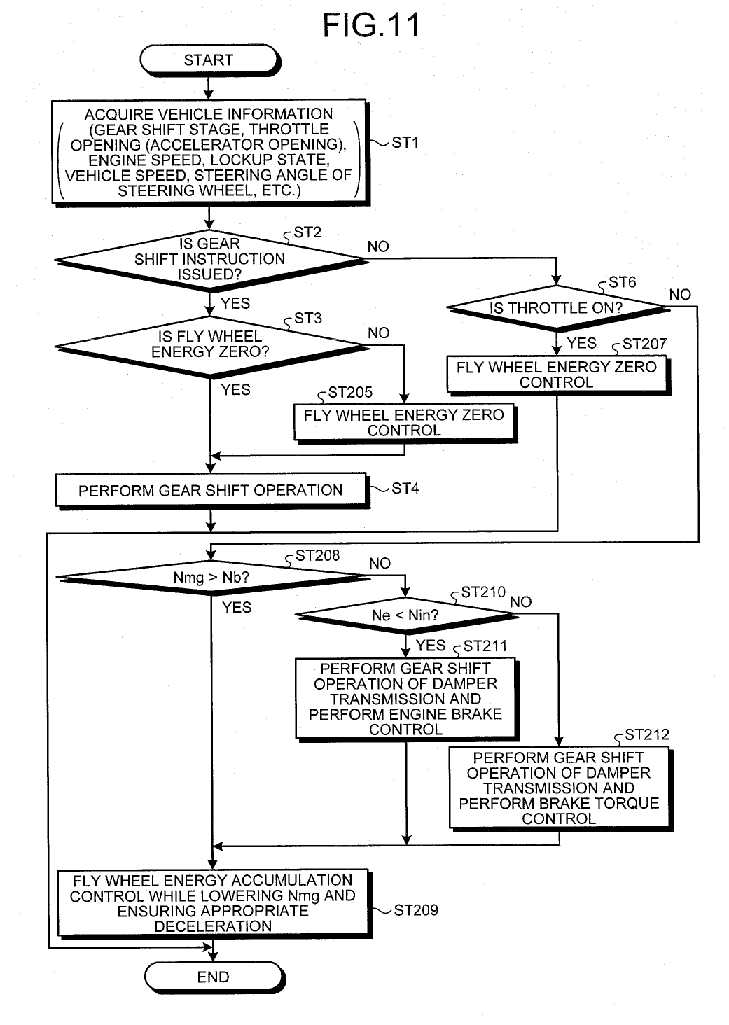

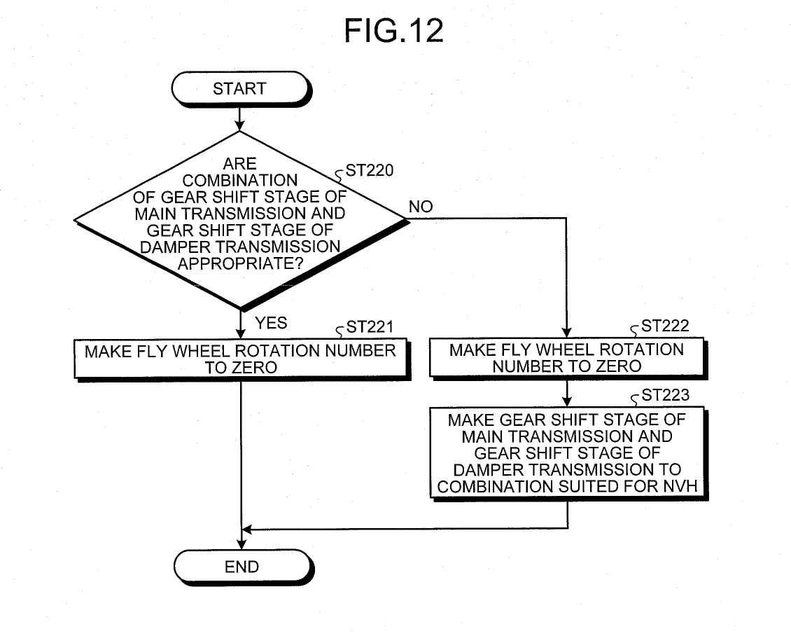

FIG. 6 is a schematic configuration diagram of a dynamic damper device according to a second embodiment, FIG. 7, FIG. 8, FIG. 9, and FIG. 10 are collinear views illustrating the operation of the planetary gear mechanism of the dynamic damper device according to the second embodiment, FIG. 11 is a flowchart explaining one example of control performed by the ECU according to the second embodiment, and FIG. 12 is a flowchart explaining one example of the fly wheel energy zero control performed by the ECU according to the second embodiment. The dynamic damper device according to the second embodiment differs from the first embodiment in that the gear ratio of the damper transmission is changed when accumulating the inertia energy. In addition, the redundant description will be omitted as much as possible for configurations, operations, and effects common with the embodiment described above. Each configuration of the dynamic damper device according to the second embodiment will appropriately reference FIG. 1, FIG. 2, FIG. 3, and the like (similarly for embodiments described below). In FIG. 1, FIG. 2, and FIG. 6, the combination of the gear ratios of the main transmission and the damper transmission is different.

As illustrated in FIG. 6, a dynamic damper device 201 of the present embodiment includes the damper main body 20 and the ECU 11. The ECU 11 of the present embodiment is also used as a first control device, a second control device, a fourth control device, and a fifth control device.

The ECU 11 of the present embodiment controls the damper transmission 40 to change the gear ratio of the damper transmission 40 and raise the output rotation number (output rotation speed) from the damper transmission 40 when accumulating the inertia energy in the rotating body 61. Thus, the ECU 11 raises the input rotation number to the carrier 63C of the damper mass device 60, and raises the rotation number of the rotating body 61 accompanying therewith to make the accumulation capacity (accumulation margin) of the inertia energy in the rotating body 61 relatively large. In other words, the ECU 11 changes the gear ratio of the damper transmission 40 to accumulate greater amount of inertia energy in the rotating body 61 when accumulating the inertia energy in the rotating body 61.

For example, as illustrated in FIG. 2, assume the ECU 11 travels the vehicle 2 with the gear shift stage 82 selected in the main transmission 8 and the gear shift stage 41 selected in the damper transmission 40 at the time of the steady travelling of the vehicle 2, and the like. The time of steady travelling of the vehicle 2 includes various times of travelling such as a case in which the driving operation is being carried out so that the driver can travel at a constant speed as much as possible, a case in which the automatic travel control by the so-called auto-cruise is being executed, and the like. In this case, as illustrated with a solid line L21 in FIG. 7, the ECU 11 uses the motor 65 as the electric motor and controls the drive of the motor 65, raises the motor rotation number, and adjusts the rotation number of the ring gear 63R toward the increasing side so that the rotation number of the rotating body 61 is substantially zero, and the damper mass device 60 is in the basic optimum resonance state.

During the steady travelling of the vehicle 2, the ECU 11 uses the motor 65 as the power generator and brake controls the motor 65 to lower the motor rotation number, as illustrated with a solid line L22 with respect to the dotted line L21 in FIG. 8, for example, when the throttle of the engine 4 is closed and the vehicle 2 is travelling through inertia, or when the brake operation (brake request operation) is turned ON and the vehicle 2 is performing deceleration travelling. The ECU 11 adjusts the rotation number of the ring gear 63R toward the speed reducing side by lowering the motor rotation number, and raises the rotation numbers of the sun gear 63S and the rotating body 61. The damper mass device 60 thus can accumulate the rotation power transmitted to the rotating body 61 as the inertia energy in the rotating body 61 with the rise in the rotation number of the rotating body 61. In this case, the damper mass device 60 can generate and regenerate power by the motor 65 to convert the kinetic energy to the electric energy and accumulate the same in the battery 66.

The ECU 11 controls the damper transmission 40 to change the gear ratio of the damper transmission 40 when the motor rotation number becomes a rated minimum rotation number, which is the minimum rotation number executable in the motor 65, in this state. As illustrated in FIG. 6, the ECU 11 changes the gear shift stage 41 of the damper transmission 40 to the gear shift stage 42.

In this case, the ECU 11 changes the gear shift stage 41 of the damper transmission 40 to the gear shift stage 42 after once having the damper clutch 50 in the released state. The ECU 11 then uses the motor 65 as the electric motor and controls the drive of the motor 65, and raises the motor rotation number and the rotation number of the ring gear 63R thus raising the rotation number of the carrier 63C, and performs control to synchronize the rotation number of the rotation member 50a and the rotation number of the rotation member 50b. Thereafter, the ECU 11 completes the gear shift operation in the damper transmission 40 with the damper clutch 50 again in the engaged state. In other words, the ECU 11 uses the motor 65 as a gear shift synchronizing device in this case.

As a result, the damper mass device 60 becomes a state in which the input rotation number to the carrier 63C is raised and the motor rotation number and the rotation number of the ring gear 63R are raised when the output rotation number from the damper transmission 40 is raised, as illustrated with a solid line L23 with respect to a dotted line L22 in FIG. 9. Thus, the damper mass device 60 can increase the accumulation capacity of the inertia energy in the rotating body 61 to accumulate greater amount of inertia energy in the rotating body 61.

Subsequently, the ECU 11 uses the motor 65 as the power generator and brake controls the motor 65, and lowers the motor rotation number, as illustrated with a solid line L24 with respect to a dotted line L23 in FIG. 10. The ECU 11 adjusts the rotation number of the ring gear 63R toward the speed reducing side, and further raises the rotation numbers of the sun gear 63S and the rotating body 61 by lowering the motor rotation number. Thus, the damper mass device 60 can accumulate greater amount of inertia energy in the rotating body 61 with further rise in the rotation number of the rotating body 61. In this case, the damper mass device 60 can generate and regenerate power by the motor 65 to convert the kinetic energy to the electric energy and further accumulate the energy in the battery 66.

When discharging the inertia energy from the rotating body 61 such as when the acceleration operation is turned to the ON state and the acceleration request is made or when the acceleration request is made by automatic travel control, for example, the ECU 11 controls each unit in the order opposite to when accumulating the inertia energy in the rotating body 61 described above. In other words, the ECU 11 uses the motor 65 as the electric motor and controls the drive of the motor 65, raises the motor rotation number, lowers the rotation numbers of the sun gear 63S and the rotating body 61, and discharges the inertia energy accumulated in the rotating body 61 as rotation power. Furthermore, in this case, the damper mass device 60 can convert the electric energy accumulated in the battery 66 to the kinetic energy and discharge the same when the motor 65 is driven and powered. Thereafter, the ECU 11 changes the gear shift stage 42 of the damper transmission 40 to the gear shift stage 41. As a result, the damper mass device 60 lowers the output rotation number from the damper transmission 40 so that the input rotation number to the carrier 63C is lowered, the motor 65 is used as the power generator and the motor 65 is brake controlled, and the motor rotation number and the rotation number of the ring gear 63R are lowered. The ECU 11 controls the drive of the motor 65 with the motor 65 as the electric motor, raises the motor rotation number, further lowers the rotation numbers of the sun gear 63S and the rotating body 61, and further discharges the inertia energy accumulated in the rotating body 61 to have the damper mass device 60 in the optimum resonance state. The ECU 11 then controls the output of the engine 4 after returning to a state in which the rotation number of the rotating body 61 is substantially zero, that is, after the damper mass device 60 is returned to the optimum resonance state, and accelerates the vehicle 2 using the power by the engine 4 as the travelling power. The dynamic damper device 1 thus can improve the fuel economy performance.

Therefore, the dynamic damper device 201 configured as above can accumulate greater energy (inertia kinetic energy of the rotating body 61 and electric energy accumulated in the battery 66) in the damper mass device 60 including the rotating body 61, and discharge greater energy as necessary, thus further improving the fuel economy performance.

The ECU 11 of the present embodiment controls the damper clutch 50 to have the damper clutch 50 in the released state and further performs the engine brake control or the brake torque control in the released state of the damper clutch 50 when changing the gear ratio of the damper transmission 40.

The engine brake control is control of adjusting the deceleration of the vehicle 2 with the engine brake (engine brake) using the rotation resistance of the engine in the released state of the damper clutch 50. In this case, the ECU 11 controls the clutch 6 and performs the clutch torque control to adjust the engine brake torque acting on the drive wheel 10 and adjust the deceleration of the vehicle 2.

The brake torque control is control of adjusting the deceleration of the vehicle 2 with the braking force generated by the braking device 12 in the released state of the damper clutch 50. In this case, the ECU 11 controls the clutch 6 to adjust the brake torque by the braking device 12 acting on each wheel including the drive wheel 10 and adjust the deceleration of the vehicle 2.

The dynamic damper device 201 thus can decelerate the vehicle 2 at the desired deceleration by the engine brake torque or the brake torque by the braking device 12 even in a case where the rotation resistance by the inertia of the rotating body 61 is no longer acting on the drive wheel 10 by once having the damper clutch 50 in the released state in the gear shift operation of the damper transmission 40. As a result, the dynamic damper device 201 can suppress giving a sense of discomfort to the driver by so-called torque slip out when the damper clutch 50 obtains the released state in the gear shift operation of the damper transmission 40.

One example of the control performed by the ECU 11 will now be described with reference to the flowchart of FIG. 11.

First, the ECU 11 acquires vehicle information based on detection results of various sensors (ST1). The ECU 11 then determines whether or not the gear shift instruction is issued (ST2). When determining that the gear shift instruction is issued (ST2: Yes), the ECU 11 determines whether or not the fly wheel energy is zero (ST3). When determining that the fly wheel energy is zero (ST3: Yes), the ECU 11 controls the main transmission 8 and the damper transmission 40 to perform the gear shift operation of actually changing the gear shift stage (ST4), terminates the current control period, and proceeds to the next control period. When determining that the fly wheel energy is not zero (ST3: No), the ECU 11 executes the fly wheel energy zero control (ST205), and proceeds to ST4 after having the fly wheel energy as zero.

One example of the fly wheel energy zero control performed by the ECU 11 of the present embodiment will now be described with reference to the flowchart of FIG. 12.

In the fly wheel energy zero control, the ECU 11 of the present embodiment first determines whether or not the combination of the gear shift stage 82, 83 of the main transmission 8 and the gear shift stage 41, 42 of the damper transmission 40 is the appropriate combination described above (ST220). The appropriate combination is a combination appropriate for NVH countermeasures as described above, and is specifically a combination of the gear shift stage 82 and the gear shift stage 41, and the gear shift stage 83 and the gear shift stage 42.

When determining that the combination is the appropriate combination (ST220: Yes), the ECU 11 uses the motor 65 as the electric motor and controls the drive of the motor 65, discharges the inertia energy to make the fly wheel rotation number (rotation number of the rotating body 61) to substantially zero and to make the damper mass device 60 in the optimum resonance state (ST221), and terminates the fly wheel energy zero control.

When determining that the combination is not the appropriate combination (ST220: No), the ECU 11 uses the motor 65 as the electric motor and controls the drive of the motor 65, discharges the inertia energy to make the fly wheel rotation number to substantially zero and to make the damper mass device 60 in the optimum resonance state (ST222). Thereafter, the ECU 11 controls the damper transmission 40 to perform the gear shift operation, causes the combination of the gear shift stage 82, 83 of the main transmission 8 and the gear shift stage 41, 42 of the damper transmission 40 to be the combination suited for NVH countermeasures (ST223), and terminates the fly wheel energy zero control.

Returning back to FIG. 11, when determining that the gear shift instruction is not issued in ST2 (ST2: No), the ECU 11 determines whether or not the throttle of the engine 4 is in the ON state (ST6). When determining that the throttle of the engine 4 is in the ON state (ST6: Yes), the ECU 11 executes the fly wheel energy zero control (ST207), terminates the current control period, and proceeds to the next control period. The fly wheel energy zero control is the control similar to the fly wheel energy zero control in ST205 described above, and thus the detailed description will be omitted.

When determining that the throttle of the engine 4 is in the OFF state (ST6: No), that is, when determining that the acceleration operation is in the OFF state and the throttle of the engine 4 is closed, the ECU 11 determines whether or not a current motor rotation number Nmg detected by the motor rotation number sensor 75 is higher than a rated minimum rotation number Nb set in advance (ST208).

When determining that the motor rotation number Nmg is higher than the rated minimum rotation number Nb (ST208: Yes), the ECU 11 executes the fly wheel energy accumulation control (ST209), terminates the current control period and proceeds to the next control period. In this case, for the fly wheel energy accumulation control, the ECU 11 uses the motor 65 as the power generator and brake controls the motor 65, lowers the motor rotation number Nmg, adjusts the rotation number of the ring gear 63R toward the speed reducing side, raises the rotation numbers of the sun gear 63S and the rotating body 61, and accumulates the rotation power transmitted to the rotating body 61 as the inertia energy in the rotating body 61. Furthermore, in this case, the damper mass device 60 generates and regenerates the power by the motor 65, so that the kinetic energy is converted to the electric energy and accumulated in the battery 66. In this case, the dynamic damper device 1 can use the rotation resistance (negative rotation force) of the rotating body 61 for the deceleration requested on the vehicle 2 by the driver (driver desiring deceleration).

When determining that the motor rotation number Nmg is smaller than or equal to the rated minimum rotation number Nb (ST208: No), the ECU 11 determines whether or not the current engine speed Ne detected by the engine speed sensor 73 is lower than the current input shaft rotation number Nin of the transmission input shaft 13 detected by the input shaft rotation number sensor 74 (ST210).

When determining that the engine speed Ne is lower than the input shaft rotation number Nin (ST210: Yes), that is, when in a state capable of acting the engine brake torque on the drive wheel 10, the ECU 11 controls the damper transmission 40 to perform the gear shift operation of the damper transmission 40 and perform the engine brake control (ST211), and proceeds to ST209.

In this case, the ECU 11 controls the clutch 6 to have the clutch 6 in the engaged state or the semi-engaged state thus performing the clutch torque control, and at the same time, controls the damper clutch 50 to once have the damper clutch 50 in the released state. In this case, the ECU 11 adjusts the magnitude of the negative transmission torque transmitted toward the drive wheel 10 through the clutch 6 according to the rotation resistance of the engine 4 to correspond to the magnitude of the deceleration torque generated by the rotation resistance by the inertia of the rotating body 61, and adjusts the engine brake torque acting on the drive wheel 10 according to the clutch torque control. The ECU 11 performs the gear shift operation of the damper transmission 40, and for example, changes the gear shift stage 41 to the gear shift stage 42, and also uses the motor 65 as the electric motor and controls the drive of the motor 65 to raise the motor rotation number and the carrier 63C, thus instantaneously synchronizing the output rotation number from the damper transmission 40 at the time of gear shift operation and the rotation number of the carrier 63C. The ECU 11 causes the damper clutch 50 to again be in the engaged state and controls the clutch 6 in synchronization therewith to immediately have the clutch 6 in the released state.

When determining that the engine speed Ne is greater than or equal to the input shaft rotation number Nin (ST210: No), that is, in a state the engine brake torque cannot be acted on the drive wheel 10, the ECU 11 controls the damper transmission 40 to perform the gear shift operation of the damper transmission 40 and to perform the brake torque control (ST212), and proceeds to ST209.

In this case, the ECU 11 controls the braking device 12, and at the same time also controls the damper clutch 50 to once have the damper clutch 50 in the released state. The ECU 11 controls the braking device 12 to adjust the magnitude of the braking torque generated by the braking device 12 to correspond to the magnitude of the deceleration torque that may be generated by the rotation resistance by the inertia of the rotating body 61, and adjust the brake torque by the braking device 12 acting on the drive wheel 10. The ECU 11 performs the gear shift operation of the damper transmission 40, and for example, changes the gear shift stage 41 to the gear shift stage 42, and uses the motor 65 as the electric motor and controls the drive of the motor 65 to raise the motor rotation number and the carrier 63C, and instantaneously synchronizes the output rotation number from the damper transmission 40 at the time of the gear shift operation and the rotation number of the carrier 63C. The ECU 11 causes the damper clutch 50 to again be in the engaged state and controls the braking device 12 in synchronization therewith to have the braking torque generated by the braking device 12 as zero.

The dynamic damper device 201 according to the embodiment described above can appropriately reduce the vibration even when the gear ratio of the main transmission 8 is changed. Furthermore, the dynamic damper device 201 achieves both reduction in vibration and improvement in fuel economy performance by using according to purpose, the function of the dynamic damper of the damper main body 20 and the function of the travelling energy accumulating device of the vehicle 2 according to the state of the vehicle 2.

According to the dynamic damper device 201 of the embodiment described above, the ECU 11 for controlling the damper transmission 40 is arranged. When accumulating the inertia energy in the rotating body 61, the ECU 11 controls the damper transmission 40 to change the gear ratio of the damper transmission 40 and raise the output rotation number from the damper transmission 40. Therefore, the dynamic damper device 201 can raise the input rotation number to the damper mass device 60, increase the accumulation capacity of the inertia energy in the rotating body 61, and accumulate greater amount of inertia energy in the rotating body 61.

According to the dynamic damper device 201 of the embodiment described above, the damper clutch 50 and the ECU 11 are arranged. The damper clutch 50 can switch to a state in which the transmission output shaft 14 and the damper mass device 60 are engaged to be able to transmit power and to a state in which the engagement is released. When changing the gear ratio of the damper transmission 40, the ECU 11 controls the damper clutch 50 to have the damper clutch 50 in the released state, and adjusts the deceleration of the vehicle 2 by the engine brake using the rotation resistance of the engine 4 or the braking force generated by the braking device 12 in the released state of the damper clutch 50. Therefore, the dynamic damper device 201 can suppress giving a sense of discomfort to the driver by the so-called torque slip out when the damper clutch 50 obtains the released state in the gear shift operation of the damper transmission 40, and for example, can suppress the drivability from degrading.

### Third Embodiment

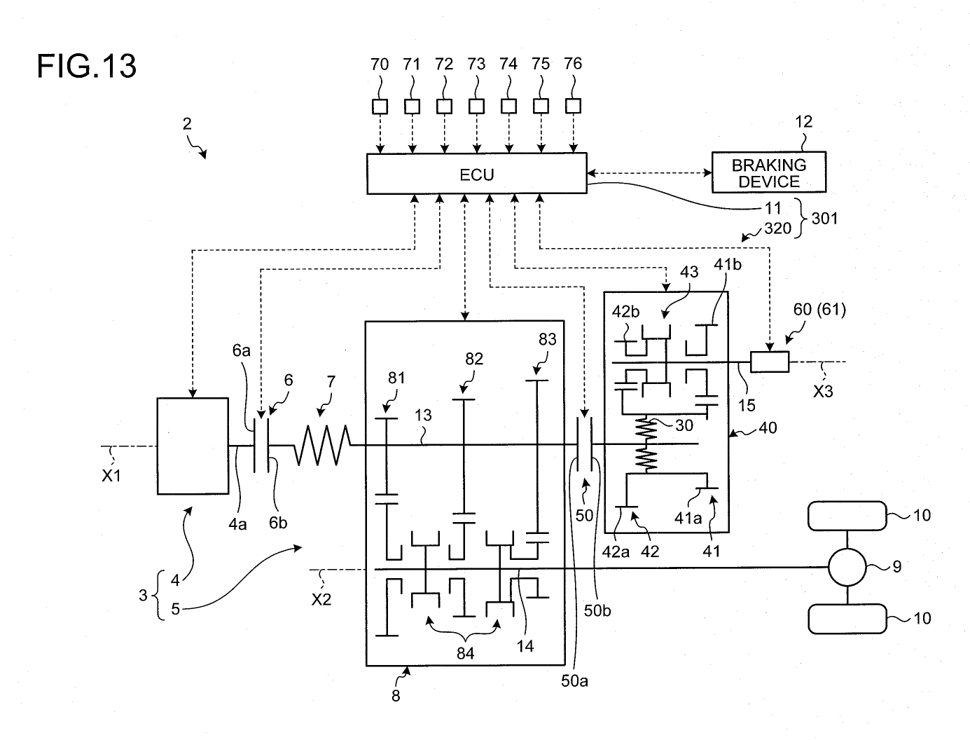

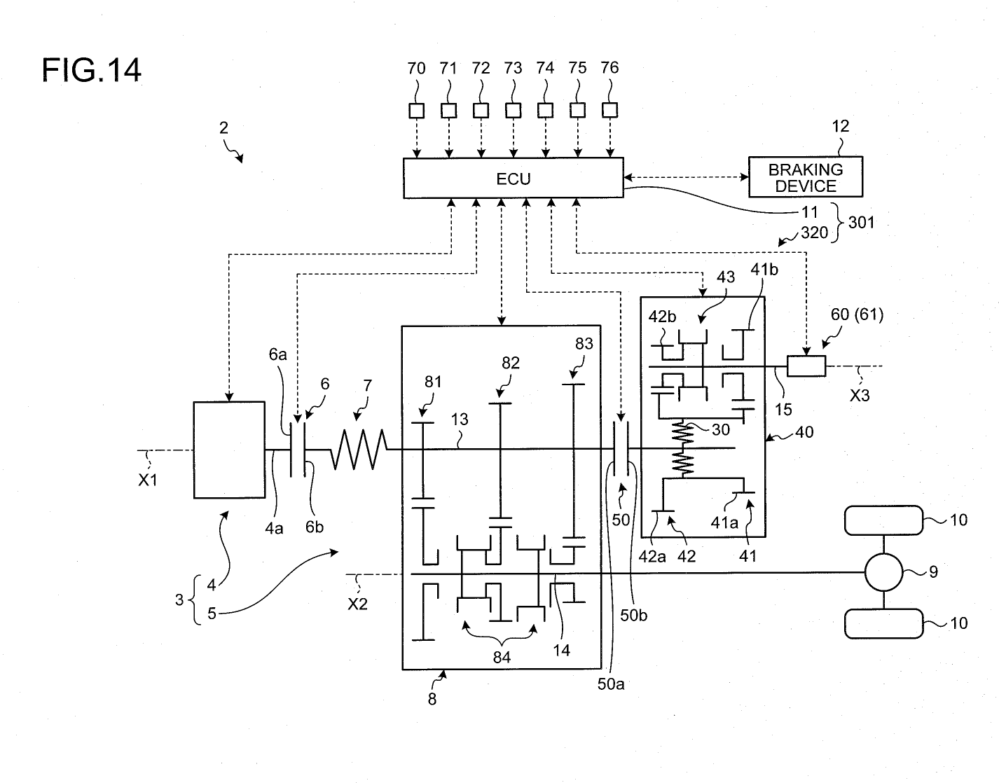

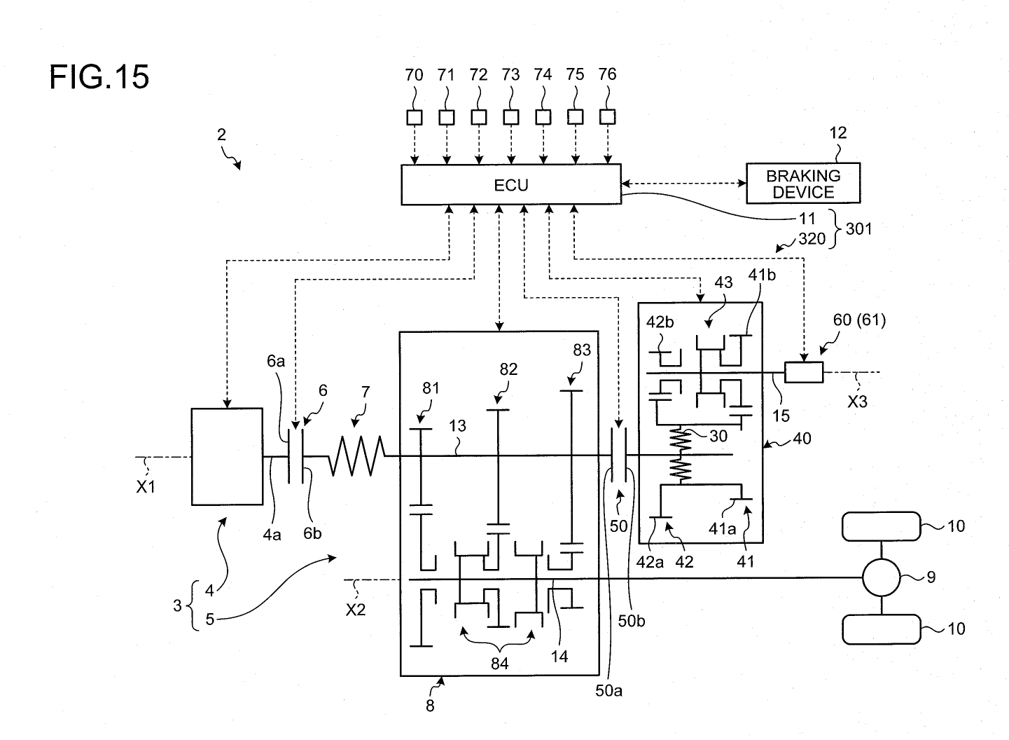

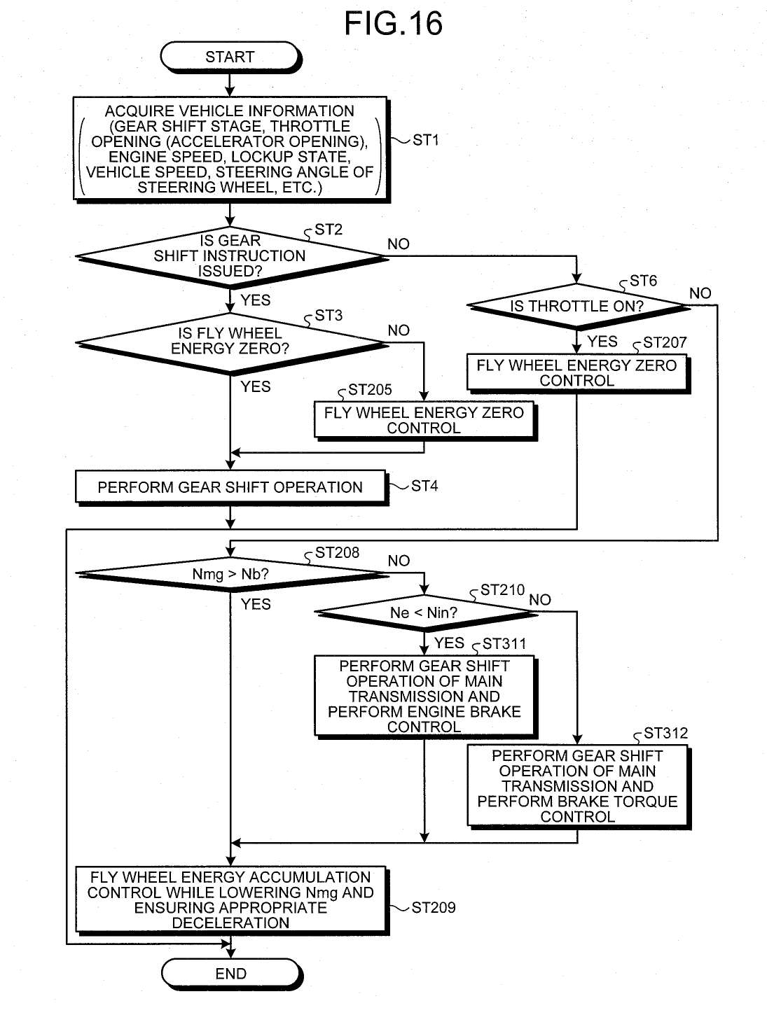

FIG. 13, FIG. 14, and FIG. 15 are schematic configuration diagrams of a dynamic damper device according to a third embodiment, and FIG. 16 is a flowchart explaining an example of control performed by the ECU according to the third embodiment. The dynamic damper device according to the third embodiment differs from the second embodiment in that the rotation shaft is the input shaft of the main transmission, and the gear ratio of the main transmission is changed when accumulating the inertia energy. In FIG. 13, FIG. 14, and FIG. 15, the combination of the gear ratios of the main transmission and the damper transmission is different.

As illustrated in FIG. 13, a dynamic damper device 301 according to the present embodiment includes a damper main body 320 and the ECU 11. The ECU 11 of the present embodiment is also used as a first control device, a third control device, a fourth control device, and a fifth control device.

The dynamic damper device 301 of the present embodiment is arranged on the rotation shaft of the power transmitting device 5 that rotates when the power from the engine 4 is transmitted, or the transmission input shaft (input shaft) 13 of the main transmission 8 configuring the drive system herein in the power train 3. The transmission input shaft 13 has the rotation axis line X2 arranged substantially parallel to the rotation axis line X3 of the damper rotation shaft 15.

The damper main body 20 of the present embodiment includes the damper mass device 60 in which the rotating body 61 (see FIG. 3) serving as the damper mass is coupled to the transmission input shaft 13 by way of the spring 30, and the damper transmission 40 arranged on a power transmission path between the spring 30 and the rotating body 61.

The damper transmission 40 is supported in a relatively rotatable manner by the transmission input shaft 13 by way of a bush, and the like with the first drive gear 41a and the second drive gear 42a integrated. The first drive gear 41a and the second drive gear 42a are coupled and elastically supported by the transmission input shaft 13 by way of the spring 30, and are relatively rotatable through the spring 30 with respect to the transmission input shaft 13. The damper transmission 40 has the first driven gear 41b and the second driven gear 42b supported in a relatively rotatable manner by the damper rotation shaft 15 by way of the bush and the like. The damper transmission 40 has the first driven gear 41b and the second driven gear 42b of one of the plurality of gear shift stages 41, 42 selectively coupled to the damper rotation shaft 15 by the gear shift mechanism 43. The damper transmission 40 gear shifts the power transmitted from the transmission input shaft 13 through the spring 30 at a predetermined gear ratio corresponding to the gear shift stage 41 or the gear shift stage 42, and transmits the same to the damper rotation shaft 15.

The damper clutch 50 can be switched to a state in which the transmission input shaft 13 and the damper mass device 60 are engaged to be able to transmit power, and to a state in which the engagement is released. The damper clutch 50 of the present embodiment is arranged on the power transmission path between the main transmission 8 and the damper transmission 40. The damper clutch 50 can be switched between the engaged state in which the rotation member 50a on the main transmission 8 side and the rotation member 50b on the damper transmission 40 side are engaged to be able to transmit power and the transmission input shaft 13 and the damper transmission 40 are engaged to be able to transmit power, and the released state in which such engagement is released. The transmission input shaft 13 in this case is divided to the main transmission 8 side and the damper transmission 40 side. A rotation member 40a is a member that integrally rotates with a portion on the main transmission 8 side in the divided transmission input shaft 13. The rotation member 50b is a member that integrally rotates with a portion on the damper transmission 40 side in the divided transmission input shaft 13.

The damper mass device 60 of the present embodiment has the carrier 63C (see FIG. 3) of the planetary gear mechanism 63, which is an input element, coupled in an integrally rotatable manner with the damper rotation shaft 15 without the damper clutch 50 interposed therebetween.

When accumulating the inertia energy in the rotating body 61, the ECU 11 of the present embodiment controls the main transmission 8 to change the gear ratio of the main transmission 8 and raise the input rotation number (input rotation speed) to the damper transmission 40. The ECU 11 thus can raise the input rotation number to the carrier 63C of the damper mass device 60 as a result, and raise the rotation number of the rotating body 61 therewith, so that the accumulation capacity (accumulation margin) of the inertia energy in the rotating body 61 becomes relatively large. In other words, the ECU 11 changes the gear ratio of the main transmission 8 to accumulate greater amount of inertia energy in the rotating body 61 when accumulating the inertia energy in the rotating body 61.

For example, the ECU 11 assumes a state in which the vehicle 2 travels at high speed, the gear shift stage 83 on the high side in the main transmission 8 is selected and the gear shift stage 42 is selected in the damper transmission, as illustrated in FIG. 13. In this case, the ECU 11 uses the motor 65 as the electric motor and controls the drive of the motor 65 to raise the motor rotation number, and adjusts the rotation number of the ring gear 63R toward the increasing side so that the rotation number of the rotating body 61 becomes substantially zero and the damper mass device 60 is in the basic optimum resonance state (see solid line L21 of FIG. 7).

For example, when the vehicle 2 starts to deceleration travel, the ECU 11 uses the motor 65 as the power generator and drive controls the motor 65, and lowers the motor rotation number to adjust the rotation number of the ring gear 63R toward the speed reducing side and raise the rotation numbers of the sun gear 63S and the rotating body 61 (see solid line L22 of FIG. 8). The damper mass device 60 thus can accumulate the rotation power transmitted to the rotating body 61 as the inertia energy in the rotating body 61 with the rise in the rotation number of the rotating body 61. In this case, the damper mass device 60 generates and regenerates the power by the motor 65 to convert the kinetic energy to the electric energy and accumulate the same in the battery 66.

When the motor rotation number becomes the rated minimum rotation number in this state, the ECU 11 controls the main transmission 8 to change the gear ratio of the main transmission 8. As illustrated in FIG. 14, the ECU 11 changes the gear shift stage 83 of the main transmission 8 to the gear shift stage 82 on the low side.

In this case, the ECU 11 changes the gear shift stage 83 of the main transmission 8 to the gear shift stage 82 after once having the damper clutch 50 in the released state. The ECU 11 then uses the motor 65 as the electric motor and controls the drive of the motor 65 to raise the motor rotation number and the rotation number of the ring gear 63R thus raising the rotation number of the carrier 63C, and performs the control to synchronize the rotation number of the rotation member 50a and the rotation number of the rotation member 50b. Thereafter, the ECU 11 completes the gear shift operation in the main transmission 8 with the damper clutch 50 again in the engaged state.

As a result, the damper mass device 60 becomes a state in which the output rotation number from the damper transmission 40 and the input rotation number to the carrier 63C are raised and the motor rotation number and the rotation number of the ring gear 63R are raised when the input rotation number to the damper transmission 40 is raised (see solid line L23 of FIG. 9). Thus, the damper mass device 60 can increase the accumulation capacity of the inertia energy in the rotating body 61 and accumulate greater amount of inertia energy in the rotating body 61.

Thereafter, the ECU 11 uses the motor 65 as the power generator and brake controls the motor 65 to lower the motor rotation number. The ECU 11 adjusts the rotation number of the ring gear 63R toward the speed reducing side by lowering the motor rotation number and can further raise the rotation numbers of the sun gear 63S and the rotating body 61 (see solid line L24 of FIG. 10). The damper mass device 60 thus can accumulate greater amount of inertia energy in the rotating body 61 with further rise in the rotation number of the rotating body 61. In this case, the damper mass device 60 generates and regenerates the power by the motor 65 to convert the kinetic energy to the electric energy and further accumulate the energy in the battery 66.

When discharging the inertia energy from the rotating body 61 such as when the acceleration request is made, the ECU 11 changes the gear shift stage 42 of the damper transmission 40 to the gear shift stage 41 to obtain an appropriate combination for the NVH countermeasure, as illustrated in FIG. 15. Thereafter, the ECU 11 controls each unit in the order opposite to when accumulating the inertia energy in the rotating body 61 described above to discharge the inertia energy from the rotating body 61.

One example of control performed by the ECU 11 will now be described with reference to the flowchart of FIG. 16.

When determining that the engine speed Ne is lower than the input shaft rotation number Nin in ST210 (ST210: Yes), the ECU 11 controls the main transmission 8 to perform the gear shift operation of the main transmission 8 and to also perform the engine brake control (ST311), and then proceeds to ST209.

In this case, the ECU 11 performs the clutch torque control by controlling the clutch 6 to have the clutch 6 in the engaged state or the semi-engaged state, and then at the same time controls the damper clutch 50 to have the damper clutch 50 once in the released state. In this case, the ECU 11 adjusts the engine brake torque acting on the drive wheel 10 by the clutch torque control. The ECU 11 performs the gear shift operation of the main transmission 8, and for example, changes the gear shift stage 83 to the gear shift stage 82 on the low side, and also uses the motor 65 as the electric motor and controls the drive of the motor 65 to raise the motor rotation number and the carrier 63C and instantaneously synchronize the rotation number of the rotation member 50a and the rotation number of the rotation member 50b. The ECU 11 then causes the damper clutch 50 to again be in the engaged state and also controls the clutch 6 in synchronization therewith to immediately have the clutch 6 in the released state.

When determining that the engine speed Ne is greater than or equal to the input shaft rotation number Nin in ST210 (ST210: No), the ECU 11 controls the main transmission 8 to perform the gear shift operation of the main transmission 8 and to perform the brake torque control (ST312), and proceeds to ST209.

In this case, the ECU 11 controls the braking device 12 and at the same time controls the damper clutch 50 to have the damper clutch 50 once in the released state.

In this case, the ECU 11 adjusts the brake torque by the braking device 12 acting on the drive wheel 10 by controlling the braking device 12. The ECU 11 performs the gear shift operation of the main transmission 8, and for example, changes the gear shift stage 83 to the gear shift stage 82 on the low side, and uses the motor 65 as the electric motor and controls the drive of the motor 65 to raise the motor rotation number and the carrier 63C, and instantaneously synchronizes the rotation number of the rotation member 50a and the rotation number of the rotation member 50b. The ECU 11 then causes the damper clutch 50 to again be in the engaged state and controls the braking device 12 in synchronization therewith to have the brake torque generated by the braking device 12 as zero.

The dynamic damper device 301 according to the embodiment described above can appropriately reduce the vibration even if the gear ratio of the main transmission 8 is changed. The dynamic damper device 301 can achieve both reduction in vibration and improvement in fuel economy performance by using according to purpose, the function of the dynamic damper of the damper main body 20 and the function of the travelling energy accumulating device of the vehicle 2.

Furthermore, according to the dynamic damper device 301 of the embodiment described above, the ECU 11 for controlling the damper transmission 40 is arranged. The ECU 11 controls the main transmission 8 to change the gear ratio of the main transmission 8 and raise the input rotation number to the damper transmission 40 when accumulating the inertia energy in the rotating body 61. Therefore, the dynamic damper device 301 can raise the input rotation number to the damper mass device 60, increase the accumulation capacity of the inertia energy in the rotating body 61 and accumulate greater amount of inertia energy in the rotating body 61.

Furthermore, the dynamic damper device 301 according to the embodiment described above can suppress giving a sense of discomfort to the driver by the so-called torque slip out when the damper clutch 50 obtains the released state in the gear shift operation of the main transmission 8, and for example, can suppress the drivability from degrading.

The dynamic damper devices according to the embodiments of the present invention described above are not limited to the embodiment described above, and various changes can be made within a scope defined by the claims.

The dynamic damper device according to the present embodiment may be configured by appropriately combining the configuring elements of each embodiment described above.

In the description made above, the planetary gear mechanism has been described with the carrier as the first rotating element that serves as the input element, the ring gear as the second rotating element that serves as the rotation controlling element, and the sun gear as the third rotating element that serves as the fly wheel element, but this is not the sole case. The planetary gear mechanism, for example, may have the ring gear as the first rotating element that serves as the input element, the sun gear as the second rotating element that serves as the rotation controlling element, and the carrier as the third rotating element that serves as the fly wheel element, or may be of other combinations.

In the description made above, the planetary gear mechanism has been described as a single pinion planetary gear mechanism, but may be a double pinion planetary gear mechanism.

The variable inertia mass device described above has been described to include the planetary gear mechanism and the rotation control device, but is not limited thereto. The variable inertia mass device has been described to variably control the apparent inertia mass by varying the rotation (speed) of the damper mass, but this is not the sole case, and may variably control the actual inertia mass of the damper mass. The rotation control device has been described to be configured including the rotating electrical machine (motor 65), but is not limited thereto, and may be configured including an electromagnetic brake device, and the like, for example, as long as it controls the rotation of the rotating element of the planetary gear mechanism forming the damper mass and varies the apparent inertia mass of the damper mass.

The vehicle described above may be a so-called “hybrid vehicle” including a motor generator serving as an electric motor that can generate power, and the like in addition to the internal combustion engine for the travelling power source.

In the description made above, the first control device, the second control device, the third control device, the fourth control device, and the fifth control device have been described to be also used by the ECU 11, but are not limited thereto and may be respectively arranged separate from the ECU 11 and configured to exchange detection signals, drive signals, information such as control command, and the like mutually with the ECU 11.

### REFERENCE SIGNS LIST

1, 201, 301 dynamic damper device
2 vehicle
3 power train
4 engine (internal combustion engine)
5 power transmitting device
6 clutch
7 damper
8 main transmission
9 differential gear
10 drive wheel
11 ECU (first control device, second control device, third control device, fourth control device, fifth control device)
12 braking device
13 transmission input shaft (rotation shaft, input shaft)
14 transmission output shaft (rotation shaft, output shaft)
15 damper rotation shaft
20, 320 damper main body
30 spring (elastic body)
40 damper transmission
50 damper clutch (engagement device)
60 damper mass device
61 rotating body (damper mass)
62 variable inertia mass device
63 planetary gear mechanism
63C carrier (rotating element)
63S sun gear (rotating element)
63R ring gear (rotating element)
64 rotation control device
65 motor

1. A dynamic damper device comprising:
a damper mass device in which a damper mass is coupled by way of an elastic body to a rotation shaft of a power transmitting device capable of gear shifting a rotation power by a main transmission and transmitting the power to a drive wheel of a vehicle; and
a damper transmission configured to be arranged on a power transmission path between the elastic body and the damper mass, and to shift the rotation power transmitted to the damper mass at a gear ratio corresponding to a gear ratio of the main transmission, wherein
the damper mass device can accumulate the rotation power transmitted to the damper mass as inertia energy.

2. The dynamic damper device according to claim 1, further comprising:
a first control device configured to control the damper mass device, accumulate the inertia energy in the damper mass at a time of non-gear shift operation of the main transmission and at the time an acceleration request operation on the vehicle is canceled, and discharge the inertia energy accumulated in the damper mass at a time of gear shift operation of the main transmission or at the time the acceleration request operation on the vehicle is performed.

3. The dynamic damper device according to claim 2, wherein
the first control device prioritizes the discharging of the inertia energy accumulated in the damper mass over generation of power by an internal combustion engine that generates power to be transmitted to the rotation shaft.

4. The dynamic damper device according to claim 1, further comprising:
a second control device configured to control the damper transmission, wherein
the rotation shaft is an output shaft of the main transmission, and
the second control device controls the damper transmission to change the gear ratio of the damper transmission and raise an output rotation speed from the damper transmission at the time of accumulating the inertia energy in the damper mass.

5. The dynamic damper device according to claim 1, further comprising:
a third control device configured to control the main transmission, wherein
the rotation shaft is an input shaft of the main transmission, and
the third control device controls the main transmission to change the gear ratio of the main transmission and raise an input rotation speed to the damper transmission at the time of accumulating the inertia energy in the damper mass.

6. The dynamic damper device according to claim 1, further comprising:
a fourth control device configured to control the damper mass device to raise a rotation speed of the damper mass at the time of accumulating the inertia energy in the damper mass.

7. The dynamic damper device according to claim 1, wherein
the damper mass device is configured to include a planetary gear mechanism including a plurality of differentially rotatable rotating elements in which the damper mass is arranged in one of the plurality of rotating elements, and a rotation control device that controls rotation of the rotating elements, provides a variable inertia mass device that variably controls an inertia mass of the damper mass, and accumulates the inertia energy or discharges the inertia energy by that the rotation control device controls the rotation of the rotating element.

8. The dynamic damper device according to claim 7, wherein
the variable inertia mass device makes the inertia mass of the damper mass relatively small in a state before the accumulation of the inertia energy by the damper mass, compared to a state after the accumulation of the inertia energy by the damper mass.

9. The dynamic damper device according to claim 1, further comprising:
an engagement device capable switching between a state in which the rotation shaft and the damper mass device are engaged to be able to transmit power and a state in which the engagement is released; and
a fifth control device configured to control the engagement device to make the engagement device in the released state and adjust deceleration of the vehicle with a braking force generated by an engine brake, which uses a rotation resistance of an internal combustion engine that generates a power to be transmitted to the rotation shaft, or a braking device in the released state of the engagement device, at the time of changing the gear ratio of the damper transmission.

10. The dynamic damper device according to claim 2, further comprising:
a second control device configured to control the damper transmission, wherein
the rotation shaft is an output shaft of the main transmission, and
the second control device controls the damper transmission to change the gear ratio of the damper transmission and raise an output rotation speed from the damper transmission at the time of accumulating the inertia energy in the damper mass.

11. The dynamic damper device according to claim 3, further comprising:
a second control device configured to control the damper transmission, wherein
the rotation shaft is an output shaft of the main transmission, and
the second control device controls the damper transmission to change the gear ratio of the damper transmission and raise an output rotation speed from the damper transmission at the time of accumulating the inertia energy in the damper mass.

12. The dynamic damper device according to claim 2, further comprising:
a third control device configured to control the main transmission, wherein
the rotation shaft is an input shaft of the main transmission, and
the third control device controls the main transmission to change the gear ratio of the main transmission and raise an input rotation speed to the damper transmission at the time of accumulating the inertia energy in the damper mass.

13. The dynamic damper device according to claim 3, further comprising:
a third control device configured to control the main transmission, wherein
the rotation shaft is an input shaft of the main transmission, and
the third control device controls the main transmission to change the gear ratio of the main transmission and raise an input rotation speed to the damper transmission at the time of accumulating the inertia energy in the damper mass.

14. The dynamic damper device according to claim 2, further comprising:
a fourth control device configured to control the damper mass device to raise a rotation speed of the damper mass at the time of accumulating the inertia energy in the damper mass.

15. The dynamic damper device according to claim 3, further comprising:
a fourth control device configured to control the damper mass device to raise a rotation speed of the damper mass at the time of accumulating the inertia energy in the damper mass.

16. The dynamic damper device according to claim 4, further comprising:
a fourth control device configured to control the damper mass device to raise a rotation speed of the damper mass at the time of accumulating the inertia energy in the damper mass.

17. The dynamic damper device according to claim 5, further comprising:
a fourth control device configured to control the damper mass device to raise a rotation speed of the damper mass at the time of accumulating the inertia energy in the damper mass.

18. The dynamic damper device according to claim 2, wherein
the damper mass device is configured to include a planetary gear mechanism including a plurality of differentially rotatable rotating elements in which the damper mass is arranged in one of the plurality of rotating elements, and a rotation control device that controls rotation of the rotating elements, provides a variable inertia mass device that variably controls an inertia mass of the damper mass, and accumulates the inertia energy or discharges the inertia energy by that the rotation control device controls the rotation of the rotating element.

19. The dynamic damper device according to claim 3, wherein
the damper mass device is configured to include a planetary gear mechanism including a plurality of differentially rotatable rotating elements in which the damper mass is arranged in one of the plurality of rotating elements, and a rotation control device that controls rotation of the rotating elements, provides a variable inertia mass device that variably controls an inertia mass of the damper mass, and accumulates the inertia energy or discharges the inertia energy by that the rotation control device controls the rotation of the rotating element.

20. The dynamic damper device according to claim 4, wherein
the damper mass device is configured to include a planetary gear mechanism including a plurality of differentially rotatable rotating elements in which the damper mass is arranged in one of the plurality of rotating elements, and a rotation control device that controls rotation of the rotating elements, provides a variable inertia mass device that variably controls an inertia mass of the damper mass, and accumulates the inertia energy or discharges the inertia energy by that the rotation control device controls the rotation of the rotating element.
